(19) United States
(12) Patent Application Publication
(10) Pub. No.: US 2005/0033758 A1
(43) Pub. Date: Feb. 10, 2005

(54) Media indexer

(76) Inventor: Brent A. Baxter, Castro Valley, CA (US)

Correspondence Address: Richard C. Litman;LITTMAN LAW OFFICES, LTD., P.O. Box 15035, Arlington, VA, 22215, US

(21) Appl. No.: 10/913,355

(22) Filed: Aug. 9, 2004

Related U.S. Application Data
(60) Provisional application No. 60/493,626, filed on Aug. 8, 2003.

(51) Int. Cl. G06F 7/00

(52) U.S. Cl. 707/100

(57) ABSTRACT

A media indexer method, a media indexer, and/or a media indexer computer useable medium. The media indexer includes a central processor and a memory carrying thereon media indexer software which carries out steps including receiving a media signal, identifying keyframes of the media signal, establishing metadata for each identified keyframe, tagging each identified keyframe with metadata established for the associated keyframe, and outputting the media signal in a form unchanged from the received media signal, and/or a form including identified keyframes of the received media signal, each identified keyframe including a representative media keyframe event with metadata associated with the corresponding media keyframe event. The media indexer can generate parallel index signals that are synchronized to the time rate of the received media signal, and can input and output data using standard compatible file formats for file sharing and data manipulations with other compatible files and software.

### CROSS REFERENCE TO RELATED APPLICATION

This application claims priority to U.S. Provisional Application Ser. No. 60/493,626, filed Aug. 8, 2003, which is incorporated herein by reference.

### BACKGROUND OF THE INVENTION

1. Field of the Invention

The present invention relates generally to indexing systems and, more particularly, to a media indexer method, a media indexer, and/or a media indexer computer useable medium.

2. Description of the Related Art

Many advances have occurred over the years regarding the transmission and display of media signals, such as audio, video, text, and other multimedia signals. The advent of cable television (TV) networks in the 1970s, such as Home Box Office (HBO), Cable News Network (CNN), etc., enabled TV users to view different programs than those being broadcast over the air. The development of the video cassette recorder (VCR) in the 1980s enabled TV users to record and/or watch desired program material at desired times. The development of the Internet and corresponding computer advances resulted in the technological capability to transmit and/or receive media signals wirelessly and/or non-wirelessly.

Considering a home user as one whom either rents and owns videos and other multimedia material, the home user typically has a rich selection of varied media equipment from stereo radio to a digital video disc (DVD) player/recorder, a video tape player/recorder, an audio tape player/recorder, a personal digital assistant (PDA), a cellular telephone (cell phone), a laptop computer, a desktop computer, a camcorder, and/or many other media devices both new and old.

The home user also typically has access to many video, audio, textual, and/or other multimedia media sources from cell phones and PDA's to laptops, to digital video recorders (DVRs), and their associated services to home networks. At home, the user typically records and plays things separately on one or more types of media devices. As it often happens, the user quickly grabs any available tape and begins recording when a desired program is discovered being broadcast to the television; sometimes a new tape is available but more often than not the user must sacrifice the contents of some older unknown recorded material. Once taped, the new video segment adds to the countless hours of uncatalogued and “forever lost moments.” Sometimes notes are written on a piece of paper fastened onto or inserted into the box of a VCR tape, or scribbled directly on the media component itself. However, such methods are inefficient and ineffective since notes can easily be lost or misplaced this is inefficient and can easily be lost or misplaced.

Home users have ever increasing choices of source media coming from satellite, Internet, cable, etc. With the arrival of DVRs, large capacity VCR-like digital hard drive recorders, and their associated services, such as TiVo and ReplayTV, that provide program choices, video on demand, automatic preference record sharing, timeshift recording capabilities, and media sharing, allow for media consumption and accumulation of drastically increased quantities. With all this comes a strong need to be able to organize and share this media and metadata information.

Media oriented businesses have the same requirements as any of the above, but are typically on a much larger scale and are usually “wired” and connected to many branches of media accessibility (such as the Internet and satellites), both directly and through contracted service organizations. Larger corporations have a proportionally larger piece of the media pie and, as such, have their media search requirements increased proportionally for such things as corporate presentations, training programs, point-of-sale informational tapes, and educational programming. For larger corporations and for that matter any business, the old adage ‘time is money’ is directly felt in the need for efficient and expedient searchable media methods since both are linked directly to company time and profit.

Law enforcement officials typically have the task of linearly searching through countless hours of recorded surveillance tapes when trying to find suspects or other video/auditory evidence. Generally, this evidence is in the form of older VHS tapes or taped phone conversations, but is usually recorded over long periods, most of which requires many man hours to review. There is a need to reduce the hours spent reviewing media evidence, where time could be better spent on other law enforcement tasks, were these videos able to be accessed more quickly and efficiently.

Video surveillance systems come in two flavors, both live and unmonitored. Live monitoring and indexing systems typically operate by being activated by a remote sensor, zone alarm, “panic button,” smoke alarm, etc., and relaying that alarm to a central monitoring service or a 911-dispatch office. For security systems using video surveillance, videotape recordings made at the scene have to be viewed some time after the actual event and usually need to be searched through significant amounts of additional recorded tape. Unmonitored surveillance and video systems not triggered by zone alarms use constant video monitoring and thus require costly and constant changing. Furthermore, such systems can run the risk of losing recorded moments if a tape runs and new recordings stop. A popular option is to use time lapse video which records desired intervals, such as every minute, every five minutes, etc. While this is useful to save tape, cost, and to reduce tape turnover, there is a risk of missing important moments during non-recorded intervals. For both forms of surveillance, there is a need to maintain constant vigilant taping while searching through entire full length tapes to efficiently find specific moments.

Video editing is a time-consuming process, as is known to anyone who has ever edited their recorded videos. Existing video editing software is typically unable to differentiate good moments from bad prior to capturing video to the computer. Generally, the software merely records the entire piece straight through both good and bad segments not only wasting computer memory but also taking valuable time. There is a need for software to distinguish keepable moments from throwaway moments prior to recording the desired moments and to access a source able to provide such a service easily.

Professional movie studios, entertainment, and advertising industries have amassed countless hours of analog film, digital video, and audio recordings with both their archives and new material. One key aspect of the entertainment industry is video editing. Additional aspects for all industries using media include the following: media evaluation, marketing, distribution, advertising, and finance. Within these industries one constant remains, the challenges to review hours upon hours of video, audio, and textual information related to movie studios and the entertainment industry. There is a huge need for large amounts of media to be accessed more quickly and efficiently, thus saving time and effort cost for the industry.

Video compact disc (VCD) players, DVD players, and the like, are digital machines with high quality video and audio capabilities and can provide a rich amount of multimedia and metadata along with video and audio. However, they also have limited scene identification capabilities being limited generally to broad chapters and scenes. There is a need to be able to use the identification and temporal capabilities while improving upon their ability to identify key moments in the media.

The communications of today are rich, filled with integrated software full of layers of varied data and content, including streaming media and multimedia, all of which move communication far beyond mere audio and video. Witness any videoconferencing presentations and office staff meetings, and you will find the use of multimedia slide show presentations showing not only pie charts and bar graphs, but audio, a soundtrack, video, and other data. This data is merged into multi-layered integrated streaming media ripe with accessible information. The types of multi-layered communications representative of internet and other communications also include metadata. Metadata is “data about data” that describes the where, when, and how data is formed, providing such particulars as author and keywords that describe the file and the audience the content is targeted for and so on, much of which is transmitted in the form of XML and HTML communication files. Resulting from this communication/technological explosion is a need to sample, collect, and display this rich streaming media data information for comparison, viewing, and manipulation, and to exploit these many varied and rich data sources.

Such advances have also resulted in a wide variety of audio/video/textual media or other multimedia signals and/or configuration types. However, techniques for indexing such audio/video/textual media or multimedia signals and related data are currently cumbersome and not user-friendly. As such, a need exists for a media indexer to provide a user-friendly method for indexing a progression of audio, video, and/or textual media signals, other multimedia signals, or any combination thereof, and providing a simple manner for selecting and/or viewing such indexed signals at a later time.

The related art is represented by the following references of interest.

U.S. Pat. No. 4,805,039, issued Feb. 14, 1989 to Katsumi Otake et al., describes an index sheet and a method for making the same, from which can be easily found the image recording medium on which a desired scene is recorded. U.S. Pat. No. 5,384,674, issued Jan. 24, 1995 to Syuzou Nishida et al., describes a still picture recording/reproducing apparatus for recording or reproducing numerous still picture composite data by using a magnetic tape as a recording medium. U.S. Pat. No. 5,388,016, issued Feb. 7, 1995 to Sadasaburoh Kanai et al., describes a magnetic tape data management method and apparatus that reduces the access time for updating and referring to directory data.

U.S. Pat. No. 5,390,027, issued Feb. 14, 1995 to Hidemi Henmi et al., describes a television program recording and reproducing system for recording a television program on a magnetic tape based on television program data contained in a received video signal. U.S. Pat. No. 5,473,744, issued Dec. 5, 1995 to David Allen et al., describes a computer-assisted method for presenting a multi-media plurality of elements. U.S. Pat. No. 5,543,929, issued Aug. 6, 1996 to Roy J. Mankovitz et al., describes a television for controlling a VCR to access programs on a video cassette tape. U.S. Pat. No. 5,546,191, issued Aug. 13, 1996 to Taketoshi Hibi et al., describes a recording and reproducing apparatus provided with a function for recording and reproducing index signals.

U.S. Pat. No. 5,636,078, issued Jun. 3, 1997 to Irving Tsai, describes a cassette recording system having both a primary memory and an auxiliary memory associated with the cassette. U.S. Pat. No. 5,742,730, issued Apr. 21, 1998 to David A. Couts et al., describes a tape control system for controlling VCRs to reposition tapes from any point to any other point utilizing time codes and VCR performance data rapidly and accurately. U.S. Pat. No. 5,786,955, issued Jul. 28, 1998 to Teruhiko Kori et al., describes a recording medium cartridge with a memory circuit for storing directory information including keyframe events.

U.S. Pat. No. 6,147,715, issued Nov. 14, 2000 to Henry C. Yuen et al., describes a television system that includes a tape indexing and searching apparatus for generating a tape index display, an electronic program guide apparatus for generating an electronic program guide display, a VCR for playing recorded television programs, and a tuner for receiving broadcast television programs. U.S. Pat. No. 6,240,241 B1, issued May 29, 2001 to Henry C. Yuen, describes an indexing VCR that maintains current information about programs recorded on tape by forming a directory/index of programs comprising a video frame of a program that is being recorded or was previously recorded along with a description or title of the program.

Great Britain Patent Application No. 2,107,953 A, published May 5, 1983, describes a method and apparatus for supplying plural kinds of television information over a television channel. An article entitled “Designing the User Interface for the Físchlár Digital Video Library,” published May 21, 2002 for Hyowon Lee et al. in the Journal of Digital Information, Volume 2, Issue 4, Article No. 103, describes a framework for designing video content browsers that are based on browsing keyframes and are used in digital video libraries.

None of the above inventions and patents, taken either singularly or in combination, is seen to describe the instant invention as claimed. Thus a media indexer method, a media indexer, and/or a media indexer computer useable medium solving the aforementioned problems are desired.

### SUMMARY OF THE INVENTION

The present invention is a media indexer method, a media indexer, and/or a media indexer computer useable medium. The media indexer includes a central processor and a memory. The memory carries thereon media indexer software, which, when executed the central processor, causes the central processor to carry out steps including receiving a media signal, identifying keyframes of a media signal, establishing metadata for each identified keyframe, tagging each identified keyframe with metadata established for the associated keyframe, and outputting the media signal in a form unchanged from the received media signal, and/or a form including identified keyframes of the received media signal, each identified keyframe including a representative media keyframe event with metadata associated with the corresponding media keyframe event. The media indexer can generate parallel index signals that are synchronized to the time rate of the received media signal, and can input and output data using standard compatible file formats for file sharing and data manipulations with other compatible files and software. The media indexer can also temporally indicate a keyframe point of the received media signal in relation to a keyframe sequence having a predetermined quantity of keyframes.

Accordingly, it is a principal aspect of the invention to provide a media indexer method, a media indexer, and/or a media indexer computer useable medium. The media indexer includes a central processor and a memory. The memory carries thereon media indexer software, which, when executed the central processor, causes the central processor to carry out steps including receiving a media signal, identifying keyframes of a media signal, establishing metadata for each identified keyframe, tagging each identified keyframe with metadata established for the associated keyframe, and outputting the media signal in a form unchanged from the received media signal, and/or a form including identified keyframes of the received media signal, each identified keyframe including a representative media keyframe event with metadata associated with the corresponding media keyframe event. The media indexer can generate parallel index signals that are synchronized to the time rate of the received media signal, and can input and output data using standard compatible file formats for file sharing and data manipulations with other compatible files and software. The media indexer can also temporally indicate a keyframe point of the received media signal in relation to a keyframe sequence having a predetermined quantity of keyframes.

It is an aspect of the invention to provide improved elements and arrangements thereof in a media indexer method, a media indexer, and/or a media indexer computer useable medium for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a schematic view of a number of media devices interconnected with a media indexer according to the present invention.

FIG. 2 is a block diagram of media indexer circuitry according to the present invention.

FIG. 3 is a media indexer functional diagram according to the present invention.

FIG. 4 is a functional diagram of a sequential flow of media keyframe events according to the present invention.

FIG. 5 is an audio/video/textual keyframe event after processing with a media indexer according to the present invention.

FIG. 6 is a multimedia keyframe event after processing with a media indexer according to the present invention.

FIG. 7 is a page image of a hierarchical browser using media indexer software according to the present invention.

FIG. 8 is an index screen browser using media indexer software according to the present invention.

FIG. 9 is a slide show browser using media indexer software according to the present invention.

FIG. 10 is a strobe navigator browser using media indexer software according to the present invention.

FIG. 11 is a strobe navigator browser showing mid strobe and black intra-keyframe moments using media indexer software according to the present invention.

FIG. 12 is a strobe navigator browser showing mid strobe and darkened intra-keyframe moments using media indexer software according to the present invention.

Similar reference characters denote corresponding features consistently throughout the attached drawings.

### DETAILED DESCRIPTION OF THE PREFERRED EMBODIMENTS

The present invention is a media indexer method, a media indexer, and/or a media indexer computer useable medium. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

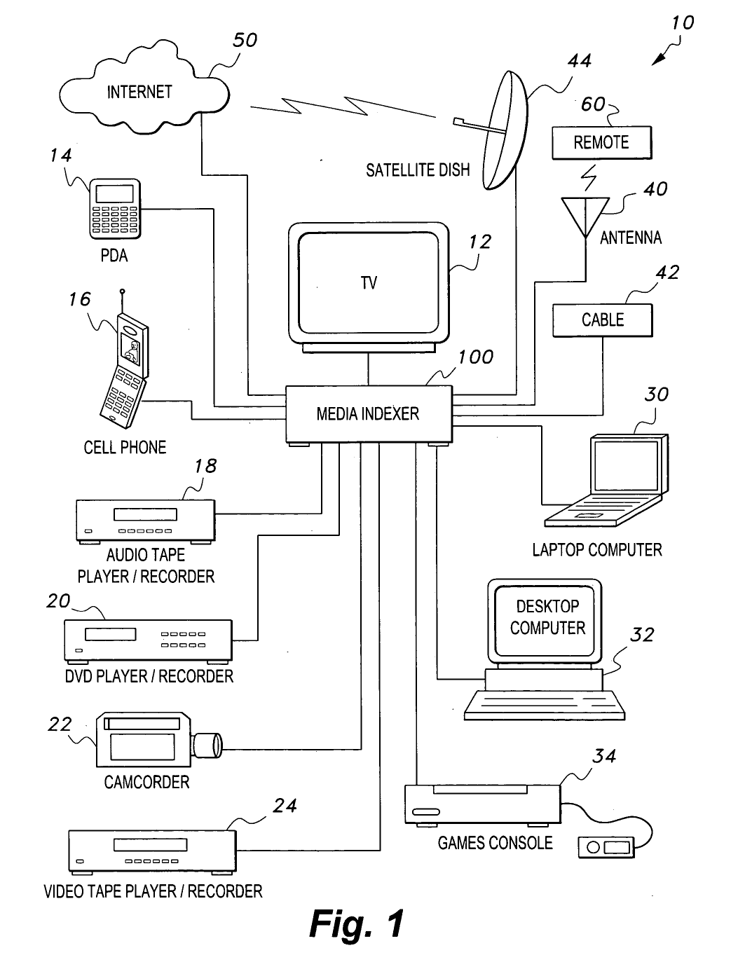

Referring to the drawings, FIG. 1 shows a media indexer 100 communicatively interconnected wirelessly or non-wirelessly with a number of media devices. The media indexer 100 is configured to receive and process a media signal by identifying keyframes of the media signal, establishing metadata for each identified keyframe, and tagging each identified keyframe with metadata established for the associated keyframe. The media indexer 100 can also receive and output a media signal unchanged, e.g., unprocessed. For example, the media indexer 100 may be turned off or be in a condition where no processing occurs, but where a media signal can electrically pass through. The processed media signal is an indexed media signal, and the media indexer 100 can output the media signal in a form unchanged from the received media signal, and/or in a form including identified keyframes of the received media signal, each identified keyframe including a representative media keyframe event with metadata. (e.g., date, time, location, etc.) associated with the corresponding media keyframe event. The media indexer 100 can generate parallel index signals that are synchronized to the time rate of the received media signal, and can input and output data using standard compatible file formats for file sharing and data manipulations with other compatible files and software. The media indexer 100 can also temporally indicate a keyframe point of the received media signal in relation to a keyframe sequence having a predetermined quantity of keyframes.

As used herein, a “media signal” is a signal that may be in the form of an audio, video, and/or textual signal, in the form of any other type of multimedia signal, or in the form of a signal of any combination thereof. A “keyframe,” as used herein, is a representative event of the media signal at a particular time (e.g., a snapshot of the media signal) and, as with a media signal, the keyframe may be in the form of an audio, video, and/or textual signal, any other multimedia signal, or any combination thereof. The term “metadata”, as used herein, is data about data for an associated keyframe, and includes definitional data about the data elements or attributes of the keyframe (e.g., name, location, time, size, data type, etc.), and/or data about the records or data structures of the keyframe (e.g., length, fields, columns, etc.). Metadata for an associated keyframe may also include descriptive information about the context, quality, condition, and/or characteristics of the keyframe.

The media indexer 100 is shown communicatively interconnected wirelessly or non-wirelessly with media devices including a TV 12, a PDA 14, a cell phone 16, an audio tape player/recorder 18, a DVD recorder/player 20, a camcorder 22, a video tape player/recorder 24, a laptop computer 30, a desktop computer 32, a games console 34, an antenna 40, a cable 42, a satellite dish 44, and a remote input/output device 60. As used here, a “media device” includes any type of audio, video, and/or textual device, any type of multimedia device, or any combination thereof, operable to provide, receive, play, and/or record any type of audio, video, and/or textual signal, any other type of multimedia signal, or any combination thereof.

Examples of media devices include an antenna, a cable, a satellite, an analog TV, a digital TV, a radio, a VCR player/recorder, a VCD player/recorder, a laser disc, a CD player/recorder, a DVD player/recorder, a video game, a computer, a camcorder, a palmcorder, a video-audio enabled cellphone or PDA, vellum film (reel-to-reel), a digital camera, a compatible computer program, or the like. The media devices may be configured for playing and/or recording a media signal on any desired storage medium, such as a video tape, an audio tape, a reel-to-reel vellum tape (using a master magnetic film, or similar method, that is re-recorded to the optical film), a laser disc, a DVD disc, and MP3 file, or the like. A storage medium in the form of a video tape configured for use with the media indexer 100 may be formatted in any desired formatting standard, such as VHS, VHS-C, S-VHS (super VHS), Hi-8, 8 MM, DIGITAL 8, BETA, MINI DV, BETACAM, BETACAM-SP, MII, U-MATIC, or the like. The media indexer 100 may also be configured in the form of media indexer circuitry, and may be incorporated and/or integrated into any type of media device. While a laptop computer 30 and a desktop computer 32 are shown in FIG. 1, the media indexer 100 may also be operably interconnected with or integrated in a media device configured as any type of computer device with a processor, such as a palmtop computer, a network computer, a PDA 14, an embedded device, a smart phone, a digital camera, a camcorder, a compatible computer program, or any other suitable computer device.

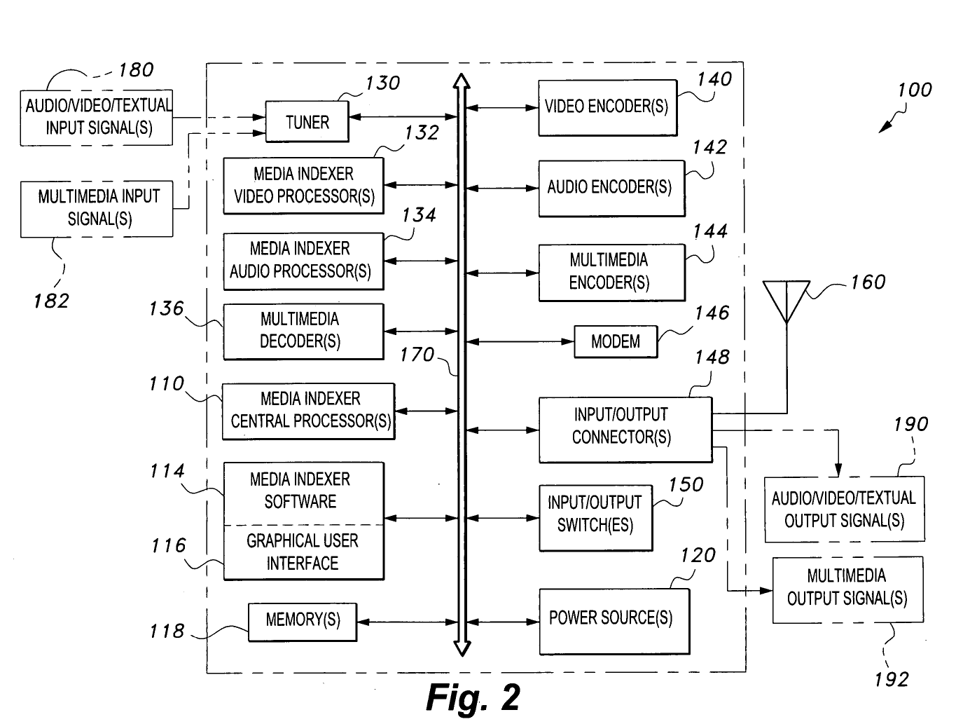

FIG. 2 shows details of the media indexer 100, which may include one or more central processors 110, media indexer software 114 with a graphical user interface (GUI) 116, one or more memories 118, and one or more power sources 120. The media indexer 100 may also include a tuner 130, one or more video processors 132, one or more audio processors 134, one or more video encoders 140, one or more audio encoders 142, one or more multimedia encoders 144, a modem 146, one or more input/output connectors 148, one or more input/output switches 150, and an antenna 160. A communication bus 16 communicatively interconnects the components 110, 114, 116, 118, 120, 130, 132, 134, 136, 140, 142, 144, 146, 148, 150, and 160 included in the media indexer 100. The media indexer 100 is configured to receive and index incoming media signals 180 and/or 182, and output indexed media signals 190 and/or 192.

The media indexer 100 may be wirelessly or non-wirelessly interconnected with remote input/output devices 60 (e.g. remote control devices) via any known technique (e.g., wireless local area network (LAN), IrDA, Bluetooth, FireWire, etc.) or through a network system via any number of switches, such as a LAN, a wide area network (WAN), an intranet, an extranet, the Internet, etc., to enable a user to wirelessly or non-wirelessly remotely control the media indexer 100 through appropriate control signals.

The media indexer 100 is configured to utilize one or more computer useable memories 118 operably configured for use with the processor(s) 110, 132, and 134. When the media indexer 100 is integrated as media indexer circuitry into other machines, the separate but parallel tracking can take the form of partitioned memories 118. The memory(s) 118 are configured in the form of a computer useable medium.

As used herein, a “computer useable medium” includes a non-volatile medium, a volatile medium, and/or an installation medium. A non-volatile medium may be a magnetic medium, hard disk, a solid state disk, optical storage, Flash memory, electrically eraseable programmable read only memory (EEPROM), parameter random access memory (PRAM), etc. A volatile medium may be dynamic RAM (DRAM), Direct Rambus® DRAM (DRDRAM), double-data rate DRAM (DDR DRAM), double-data rate synchronous DRAM (DDR SDRAM), enhanced DRAM (EDRAM), enhanced synchronous DRAM (ESDRAM), extended data out (EDO) DRAM, burst EDO (BEDO) DRAM, fast page mode DRAM (FPM DRAM), Rambus DRAM (RDRAM), SyncLink® DRAM (SLDRAM), synchronous RAM (SRAM), synchronous DRAM (SDRAM), synchronous graphic RAM (SGRAM), video RAM (VRAM), window RAM (WRAM), etc. An installation medium may be a CD-ROM, a DVD, a DVD−R, a DVD+R, a DVD−RW (writable), a DVD+RW (writable), a floppy disk,. a removable disk, etc., on which computer programs are stored for loading into a computer device.

The media indexer 100 may be configured with the memory(s) 118 configured in the form of a mass storage unit to provide efficient retrieval capability of a large volume of media moments. Such a media jukebox unit enables parents to program a collection of favorite media moments for children to view and could be used to pre-edit out, or exclude undesirable movements from media play. Thus, parents can choose what their children watch without having to be present. Additionally, this is very appealing to those who like to watch, hear, and/or read “Cliff Notes” versions of media recordings. Likewise, users can mix and match various segments and types of media such as text, music, digital pictures, video, and audio segments for play and entertainment. Such results could range in variety and may even resemble a multimedia collage. In addition to home use, such multimedia collage collections can be used in businesses, retail stores, or similar venues for the purposes of advertising, entertainment, or other purposes.

The media indexer software 114 and GUI 116 may be stored in the memory(s) 118, as well as on a data communications device, such as the modem 146, connected to the bus 160 for wirelessly and/or non-wirelessly connecting the media indexer to a LAN, a WAN, an intranet, an extranet, the Internet, etc. The media indexer software 114 and GUI 116 are stored in the memory(s) 118 and execute under the direction of the processor(s) 110, 132, and 134.

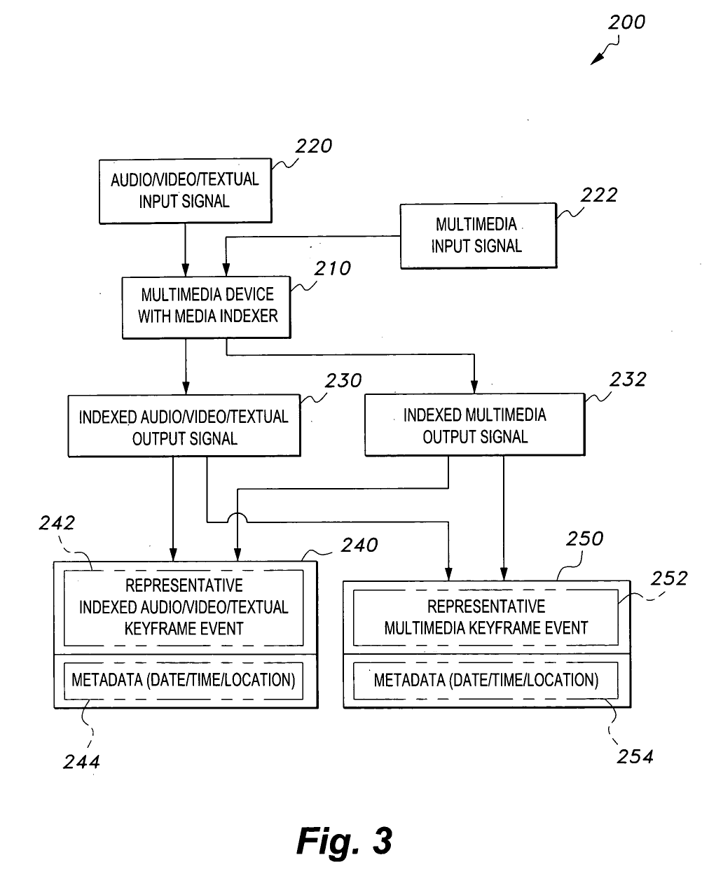

The process 200 shown in FIG. 3 illustrates how a media device configured with a media indexer or media indexer circuitry 210 receives a media input signal 220 or 222. The media input signal may be in the form of an audio, video, and/or textual input signal 220, in the form of any other type of multimedia signal 222, or in the form of a signal of any combination thereof. The media input signal 220 or 222 is processed by identifying keyframes of the media signal 220 or 222, establishing metadata for each identified keyframe, and tagging each identified keyframe with metadata established for the associated keyframe. The processed media signal produces an indexed media output signal 230 or 232, and outputs the indexed media signal 230 or 232 in the form of output media events 240 or 250, each including a representative media keyframe event 242 or 252 with metadata 244 or 254 (e.g., date, time, location, etc.) associated the corresponding media keyframe event 242 or 252.

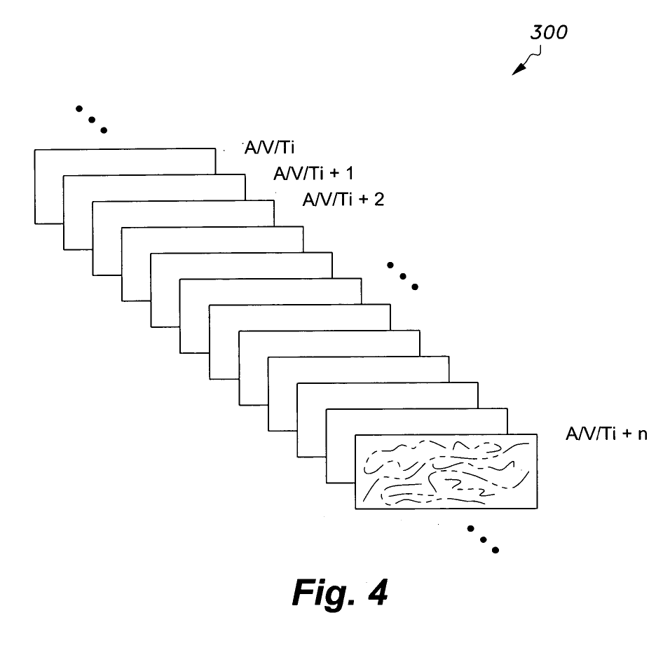

FIG. 4 illustrates a progression 300 of indexed media events in the form of audio, video, and/or textual events. The media indexer 100 can record and store metadata index information associated with each media event in the memory(s) 118. The media indexer 100 can also output an indexed metadata signal that includes index information associated with the processed audio/video/textual (A/V/T) signal, the processed multimedia signal, or any combination thereof. The indexed metadata signal includes time-counter and/or index-identification data that correspond to media keyframe event sequence locations (e.g., A/V/Tᵢ, A/V/Tᵢ₊₁, A/V/Tᵢ₊₂, . . . A/V/Tᵢ₊ₙ). When the media indexer 100 outputs such an indexed metadata signal including time-counter and/or index-identification data, the indexed metadata signal may be synchronized with the corresponding processed output audio/video/textual signal, the processed output multimedia signal, or any combination thereof.

DVD discs store digital media data. The digital media data may be formatted and encoded according to any desired formatting standard protocol before being stored on a DVD disc. Such standards include DVD VOB, VideoCD, CD-I, Moving Pictures Expert Group-1 (MPEG-1), MPEG-2, CD-ROM, or CD-DA. A DVD player/recorder reads the encoded media data from the DVD and decodes it for reproduction on a computer, television, or other interconnected media device. A digital media signal includes an audio data stream, a video data stream, and a sub-picture video stream. The audio stream, video stream, and sub-picture video stream are separately processed. The sub-picture video stream may include index signaling according to the invention.

As described above, the media indexer 100 may be configured as an independent or stand-alone device operable for interconnecting between a media signal source device(s) and a media signal output device(s). Alternatively, the media indexer 100 may be integrated into a media device, such as an analog TV, a digital TV, a radio, a CD player/recorder, a DVD player/recorder, a computer display, or the like. The media indexer 100 may be configured for receiving media signals from one or more media source(s), and may be configured for outputting a processed media signal with an index signal according to the invention to one or more output media device(s) according to the desires of the user.

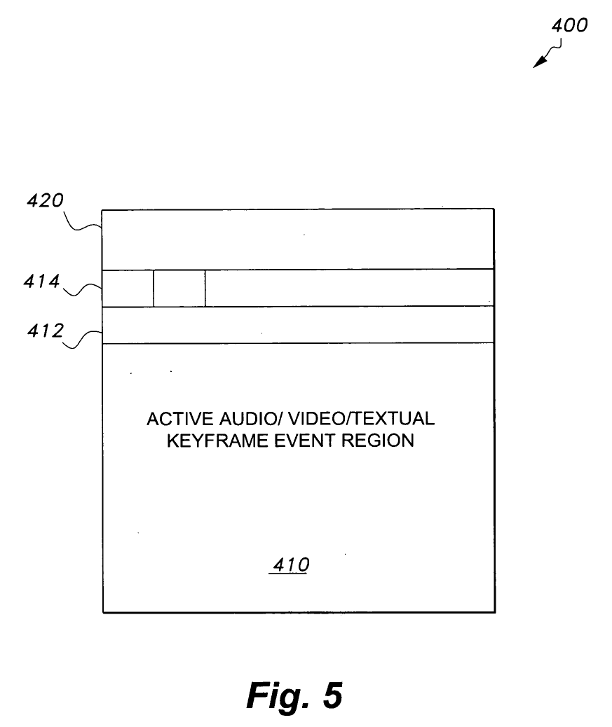

As described above, the media indexer 100 may receive any type of media signal, such as an analog media signal, a digital media signal, a multimedia signal, and/or any combination thereof. Media signals may be sent over airwaves, cable, satellite, or from VCRs, VCDs, DVDs, laserdiscs, computers, or the like. An analog media signal appears as a sequence of fields or frames. As shown in FIG. 5, each field or frame 400 of an analog media signal includes an active audio/video/textual keyframe region 410, and vertical blanking interval (VBI) information is contained in selected video lines 420. The active picture region 410 is structured as sequential horizontal lines containing a fixed number of pixels for each line.

The video encoder 140 of the media indexer 100 processes this analog media signal by separating groups of lines from the signal into a series of horizontal slices 412 and 414. Each slice is further separated into square blocks, called macroblocks, which are a predetermined number of pixels by a predetermined number of lines in size. The media indexing information may be included in the VBI video lines of the analog/video signal, along with control, sequencing and framing information. Any type of analog media signal may be input into the media indexer 100, such as an NTSC (National Television Systems Committee) media signal, a PAL (Phase Alternating Line) media signal, a SECAM (Systeme Electronique Couleur Avec Memoire) media signal, or the like.

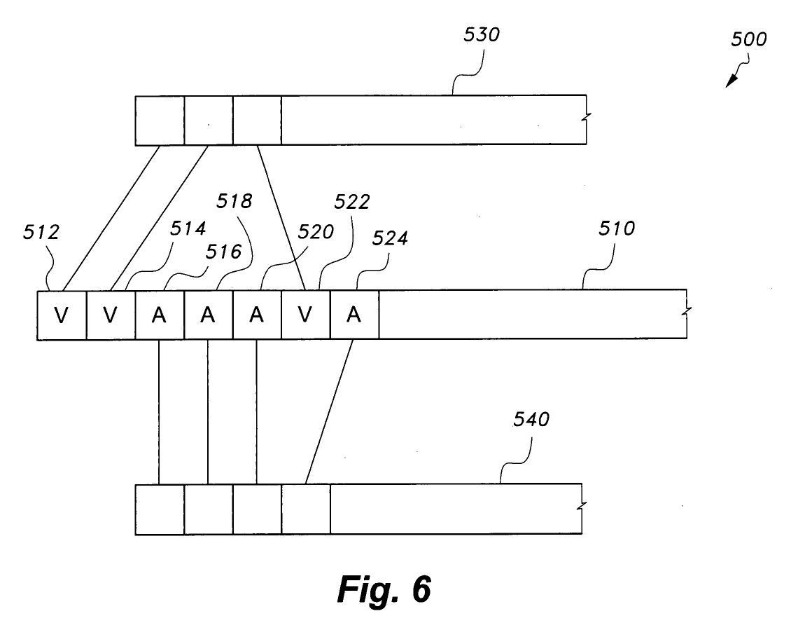

The image 500 shown in FIG. 6, illustrates how a digital media signal in the form of a multimedia signal 510 includes a plurality of video bits 512, 514, 522, etc. from a video signal 530, and a plurality of audio bits 516, 520, 524, etc. from an audio signal 540. The video and audio bits 512, 514, 516, 518, 520, 522, 524, etc., are sequenced together to form the multimedia signal 510.

Any type of digital media signal may be input into the media indexer 100, such as a VideoCD media signal, a CD-I media signal, a Moving Pictures Expert Group-1 (MPEG-1) media signal, an MPEG-2 media signal, an MPEG-6 media signal, an MPEG-7 media signal, a Motion JPEG (Joint Picture Expert Group) media signal, a Real Video media signal, an Apple QuickTime media signal, or the like.

A radio frequency (RF) media signal 180 to the media indexer 100 passes through the tuner 130 in order to select a particular channel. The video portion of the tuner output signal is processed by the video processor(s) 132. The audio portion of the tuner output signal is processed by the audio processor(s) 134. The output signals of each of the video and audio processor(s) 132 and 134 are compressed in the video encoder 140 and stored in the memory(s) 118.

The media indexer 100 may be configured as a device for interconnection between a media source device and a media output device. The media indexer 100 includes electronics that enable the media indexer 100 to process the media signal from the media source by translating the protocol of the media source device to an industry standard protocol of the media signal. The media indexer 100 is configured for outputting the media signal in a protocol that corresponds to the interconnected media display, which may be any type of media display, such as a cathode ray tube, a liquid crystal display, a plasma display, a field emission display, a digital micrometer display, an LCD touchscreen display, combinations thereof, or the like.

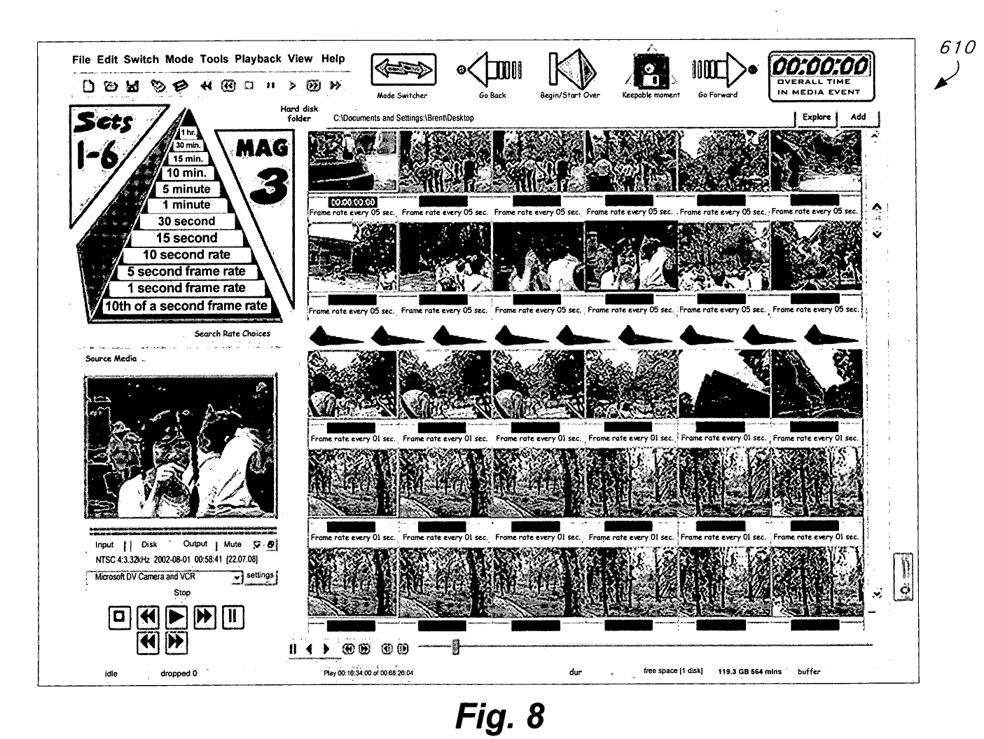

The memory(s) 118 of the media indexer 100 include computer useable media indexer software 114 and the GUI 116 stored therein. The media indexer software 113 and the GUI 116 include a plurality of computer instructions that may be carried on any computer useable medium according to the desires of the user. The GUI 116 may be configured in a variety of ways including a hierarchical browser GUI 600, an index screen GUI 610, a slide show GUI 620, a strobe navigator GUI 630, a strobe navigator GUI 640 configured to show mid strobe and black intra-key frame moments, and a strobe navigator GUI 650 showing mid strobe and darkened intra-keyframe moments (see FIGS. 8, 9, 10, 11, and 12, respectively).

The GUI 116 provides a user with a convenient and efficient interface with multiple tools and pre-programmable/changeable preference options for locating desired keyframe moments. Such tools can include pull-down menus, non obtrusive pop-ups that do not interfere with or slow down the search at hand. The GUI 116 may also have icons configured to react to user preferences via clicking a mouse location, touching a touchscreen, fluid reaction to movement of a mouse location, etc. For example, when a cursor pauses over a keyframe event, that keyframe event can become highlighted and an initial unobtrusive pop-up or pull-down menu prompt can appear. The user can ignore this symbol and continue moving their cursor around or the user can signal the media indexer 100 through a pre-programmed method via the media indexer software 114, such as clicking on the keyframe or the like) that another activity is desired.

After receiving the signal, a secondary pop-up can be provided that asks what the user would like to do such as switch viewing modes, go to the moment selected by the keyframe, change the keyframe display rate, print the keyframe event, start over, save a moment, go back, a pyramid layer, or ignore and continue, etc. Switching viewing modes can change the GUI 116 from one type of GUI to another, such as from the index screen GUI 610 to the slide show GUI 620, or the like. A keyframe moment can be saved by marking the keyframe and associated timestamp period for later manipulation or choice options. Depending on the user's choice the display reacts accordingly.

The media indexer software 114, when executed by a processor(s) 110, 130, 132, enables the media indexer 100 and/or media indexing circuitry to interpret VBI data of analog TV media signals and/or the sub-image stream of digital media signals, and read time-counter and index-identification data that may be included in incoming media signals. The media indexer software 114 enables the media indexer 100 to provide time-counter and index-identification data to outgoing TV media signals in the form of supplemental parallel broadcast index signals via a dual broadcast linking connector (e.g., a form of splicing cable). The media indexer software 114 enables the media indexer 100 to display one or more still index keyframe events from incoming media signals at any predetermined time interval, such as fractions of a second, one or more seconds, one or more minutes, or the like. The still index keyframe events may be low resolution still keyframe events, resulting in low memory consumption.

The still index keyframe events may be interactively presented to a user of the media indexer 100 in a pyramid layering manner. For example, when a user is trying to locate a particular desired scene viewed from a rental video tape, he/she may instruct the media indexer 100 to display still index keyframe events at a first time interval selected by the user, such as ten minutes (e.g., to provide only eighteen still index keyframe events for a 180 minute tape), twenty minutes, or the like. The user may then locate and identify an approximate timeline for the desired scene between forty and fifty minutes on the rental video tape by using a corresponding parallel counter on the media indexer 100 (the rental video tape does not need to rewound and/or forwarded from the current video tape location).

The user may then cause the media indexer 100 to display still index keyframe events at a second time interval smaller than the first time interval, such as one minute or the like, between the identified forty to fifty minute area, to display another ten still index.keyframe events of the rental video tape at one minute intervals between the identified forty to fifty minute area. The user may then identify a particular desired moment at forty-three minutes in the rental video tape. The user may then cause the media indexer 100 to send a command signal to an interconnected VCR device that is playing the rental video tape, cause the VCR device to rewind and/or forward the rental video tape to the desired forty-three minute location, and play the rental video tape to enable the user to view the desired scene on an interconnected media output device; or the user may continue searching instead.

The user may then cause the media indexer 100 to display still index keyframe events at a third time interval smaller than the second time interval, such as one second or the like, between the identified forty-three minute area, to display still index keyframe events of the rental video tape (for example) at one second intervals between the identified forty-three minute area.

The user may then identify a particular desired moment at forty-three minutes and twenty-seven seconds in the rental video tape. The user may then cause the media indexer 100 to send a command signal to an interconnected VCR device that is playing the rental video tape, cause the VCR device to rewind. and/or forward the rental video tape to the desired forty-three minute and twenty-seven second location. The user may then cause the media indexer 100 to record a still index image of this exact time into the memory(s) 118 of the media indexer 100 in a high resolution format to enable the user to print the high resolution still index image on an interconnected printer via a computer hook-up, a removable memory card, or the like. The quality of the still index image may vary according to the desires of the user, such as low quality, mid quality, high quality, super high quality, or the like. While the above example illustrates the use with a VCR, the media indexer 100 functions similarly and equally well with any compatible media source.

The media indexer software 114 enables the media indexer 100 to capture the fluid action of desired moments of a media signal, such as in a strobe-like effect, stop motion photography used in sporting events, or the like. A user may identify a particular moment of a stored and indexed media signal via the pyramidal index identification. The user may then cause the media indexer 100 to output desired stop motion still indexed keyframe events from the identified particular moment for a desired amount of time to display a desired amount of action. If still index keyframe events during the desired time interval have not been recorded by the media indexer 100, the user may cause the media indexer 100 to send an output command to cause an interconnected VCR to rewind and/or forward a video tape to the starting point of the desired time interval, and record still index keyframe events during the desired time interval according to the desires of the user.

The media indexer 100 may be configured to enable a user to rearrange keyframe events in a desired manner by recombining the keyframe events to form a time lapse sequence of keyframe events at desired intervals from the collected keyframes that can be further sorted or manipulated. This enhances the ability of the user to organize highlight moments of such events as a sporting event. For example, the user could organize sequences associated with touchdowns in a football game, hits in a baseball game, successful golf shots in a golf game, winning tennis shots during a tennis match, or create a best sports moments collage, etc.

The user may then cause the media indexer 100 to output and cause to be displayed fluid stop motion still index keyframe events in index-fashion of the desired action sequence in speeds according to the desires of the user, such as every half second, every quarter second, every eighth second, or the like. As a result, seven seconds of stop motion indexed media signal for a desired speed of an eighth second may be displayed on an interconnected media output device as fifty-six still index keyframe events (eight keyframe events per second for seven seconds equals fifty-six still index keyframe events). Once viewed and having found the desired speed of the stop motion movement keyframe events, the user may then cause the media indexer 100 to again save the series of stop motion still index keyframe events as a multi-sequence form of an index sheet. This index collage of stop motion still index keyframe events may be configured in the form of a sequence photo which may be stored in the memory(s) 118, transferred to an interconnected computer or compatible computer program, copied, and/or printed on an interconnected printer.

The media indexer software 114 enables the media indexer 100 to output and cause to be displayed a multi-screen index sampling of still index keyframe events having a desired frequency. For example, a user may want to view still index keyframe events of a movie at ten second intervals. Such still index keyframe events may be displayed in a page by page manner or scroll method, whereby each page (or full screen scroll respectively) includes still index keyframe events for a ten second interval. For still index keyframe events stored at six keyframe events per minute, a one hundred and twenty minute movie then has seven hundred and twenty still index keyframe events. The user may want to have each page or full screen scroll of an output display show one hundred still index keyframe events, resulting in seven full pages of one hundred keyframe events and an eighth partial page of twenty still index keyframe events. Each page may be reached via a next page command/arrow, a previous page command/arrow, a scroll arrow, or the like (e.g., similar to changing pages on the internet while browsing). Alternatively, each screen page may be automatically displayed until commanded to stop by touching or clicking on the screen. If the user wants to view still index keyframe events at one second intervals, they would have to sift through seventy-two hundred still index keyframe events that would appear on seventy-two pages of still index keyframe events. Also, such still indexes may be played on an automatic play such as in a slide show manner.

A user may move in any direction during a search (e.g., forward, backwards, etc.) and may change parameter as desired to refine the search. A display interconnected with the media indexer 100 equipped with a touch sensitive screen enables a user to display multiple search screens according to different parameters, and select among the multiple search screens by touch, resulting in the ability of a user to interactively retrace and/or refine a search while globally viewing prior steps or decisions. Such a multi-layering/viewing of pyramid steps also provides a visual aid for a non touch sensitive screen. In either case, the ability to move quickly and easily through multiple search screens results in a highly user friendly quality.

The media indexer software 114 enables the media indexer 100 to output still index keyframe events that may be printed on a printer interconnected with the media indexer 100. The media indexer software 114 also enables the media indexer to index audio signals in the form of sound-bites or sound segments recordings. The media indexer 100 may be configured to record a segment of pre-programmed radio programs, or music from a record player, CD, cassette tape, or the like, in the same manner as conventional VCRs are configured to record TV media signals. Pre-programmed and timed audio segments can be set to record on any predetermined day and any predetermined time from either a TV broadcast, a radio broadcast, or the like.

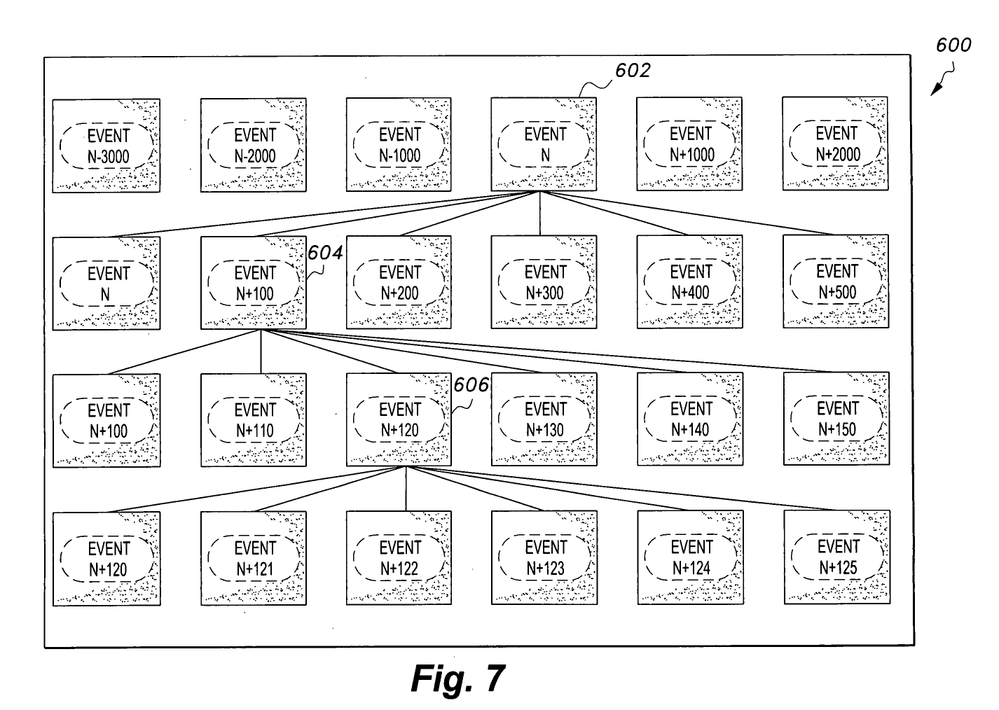

FIGS. 7 through 12 illustrate how the GUI 116 of the media indexer 100 may be configured. The GUI 600 shown in FIG. 7 is a hierarchical browser. The GUI 600 allows breakdown display of keyframes in a highly interactive way (e.g., quick response). Diagonal lines appear and visualize a hierarchical arrangement of keyframes. As a mouse cursor or pointer moves over a keyframe, more detailed keyframes appear one level below.

The GUI 610 shown in FIG. 8 is an index screen GUI 610. The index screen GUI 610 is configured to enable a user to interactively instruct the media indexer 100 to display still index keyframe events at desired intervals and display preferences, and to enable a user to keep track of what interval/display methods are currently on as well as to have access to easily change from one method to another. Thus, the chosen interval can be displayed through color-coordinated code notation (e.g., highlighted and printed level indicators). The keyframe event rate may be shown via a highlighted rate displayed on a search rate pyramid indicator. The keyframe rate can be printed on each frame accordingly in an index scroll version of the index screen GUI 610, or in a visual location using the slide show GUI 620. Consequently, for each GUI configuration, the current search position highlighted within the scrolling display of keyframes in the index screen GUI 610, is also displayed with the same color code on all indicators such as an increment layers indicator, a pyramid level numeric indicator, a constant source media tracking screen and keyframe indicator (within a coordinated keyframe rate color coding), etc.

The index screen GUI 610 displays keyframe events of keyframes similar to the kind one receives at a photo developing place. However, this time the index keyframe events are key frames of “snapshots” of media moments displayed at programmable intervals. The sets of indexed keyframe events may be limited to a number of keyframes within a pyramid layer. However, all indexed keyframe events can optionally be displayed with the ability to scroll down (see scroll bar text) should there be many keyframe events to browse through, such as when a finer interval of keyframes are set (such as every two minutes or the like). If this is chosen, the user can set options either to scroll lengthwise or move page to page (similar to web page movement on the internet).

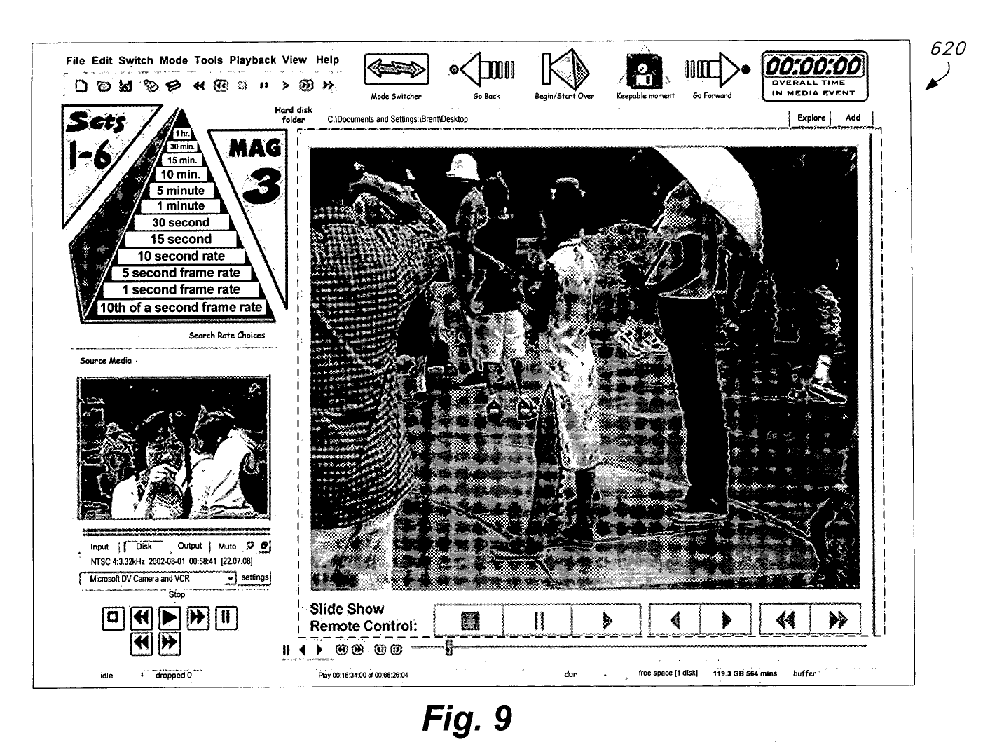

The slide show GUI 620, as shown in FIG. 9, is configured to show a series of index keyframe events larger than the keyframe events shown in the index screen GUI 610. The keyframe events are in the form of a slide show where one image is displayed over another. This larger display is useful for smaller screens such as PDAs and handheld units. The rate can be increased or decreased as desired as well as automatic “play” including other typical slide show commands such as pause, continue, stop, and manual forward or reverse. When one is viewing in slide show mode they are actually viewing the keyframe “snapshots” in a series. These results, depending upon speed of slide show, can result in a virtual time-lapse video viewing.

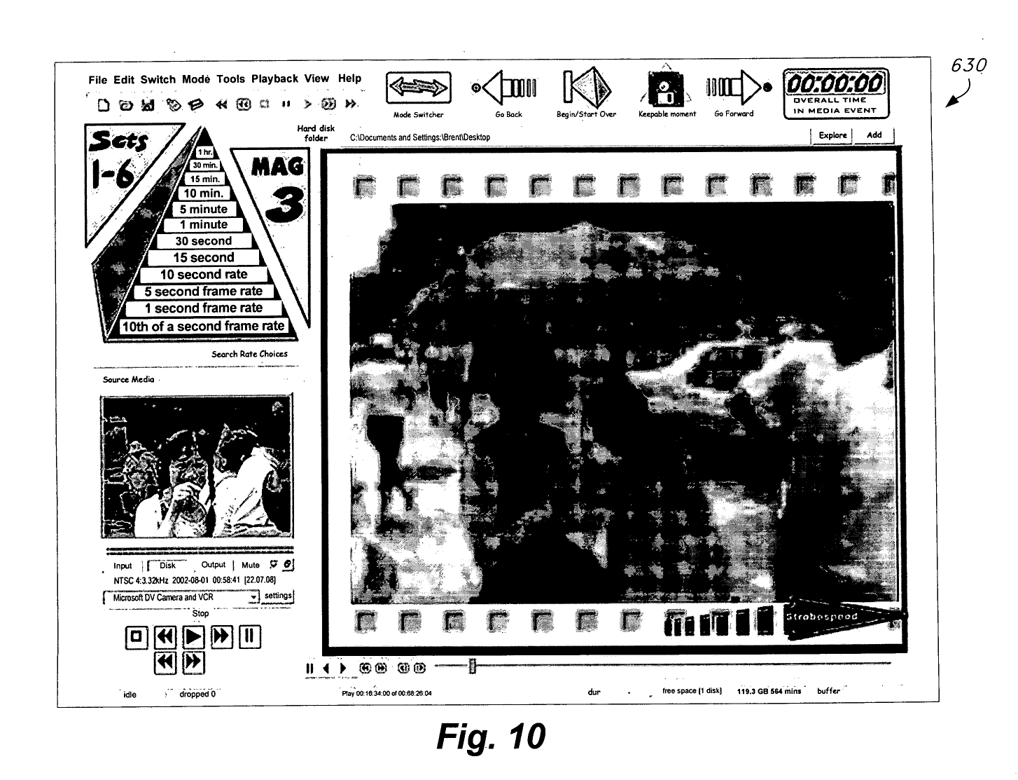

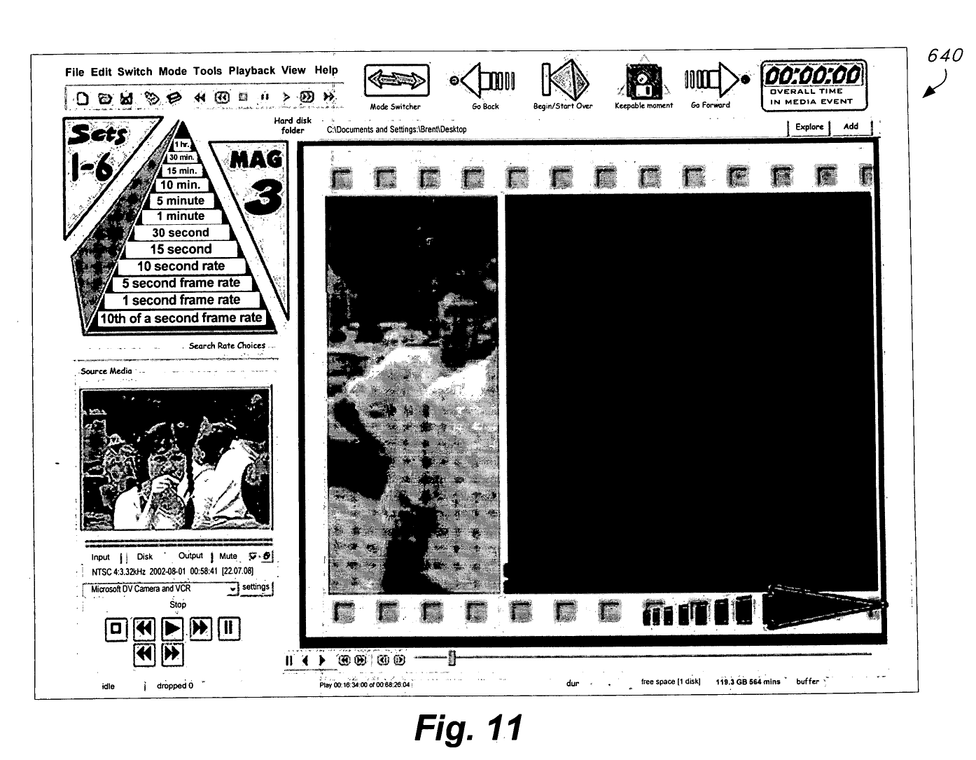

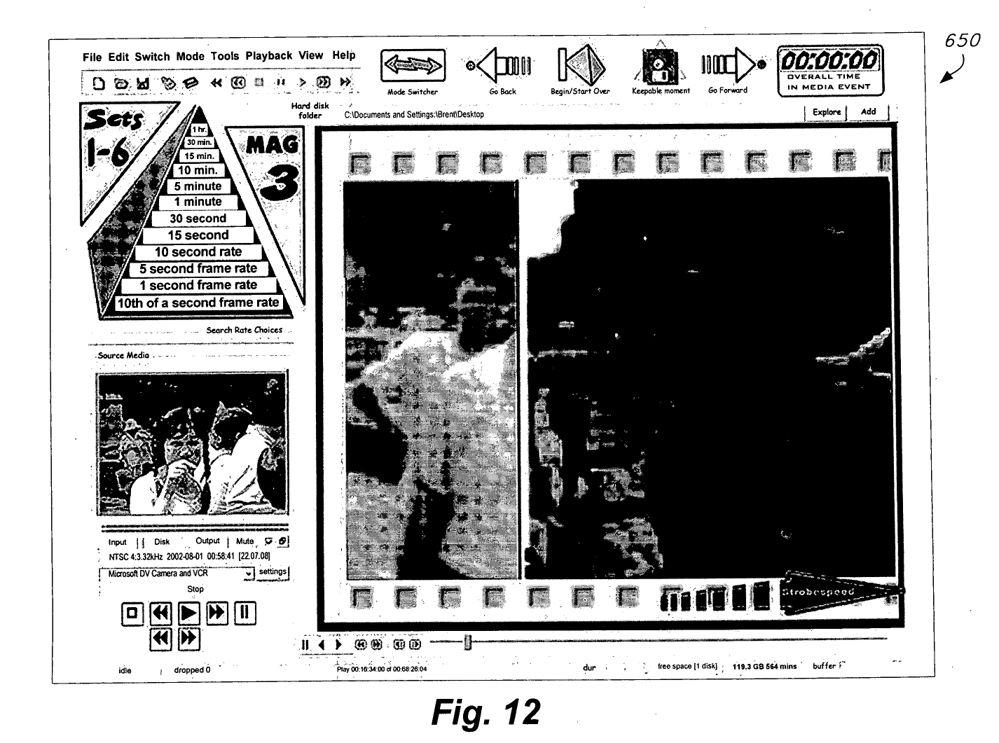

The strobe navigator GUI 630 in FIG. 10 enables a user to view a keyframe event in an enlarged manner, and enables a user to advance through the keyframe images via a strobespeed icon. The strobe navigator GUI 640 in FIG. 11 enables a user to view a visible keyframe event with visible keyframe events between strobe darkened intervals where the strobe reveals shadowy images while strobing, and enables a user to advance through the keyframe images via a strobespeed icon. Strobe shadowy intervals allow the viewer to be able to identify every moment between visible strobe keyframes. In addition, the percentage of strobe shadowing can be adjusted by programming percentages of shadow darkness. The strobe navigator GUI 650 in FIG. 12 enables a user top view visible keyframe events shown in between strobe black intervals (intra-keyframe moments), and enables a user to advance through the keyframe images via a strobespeed icon.

The media indexer software 114 provides flexibility and many choices that are easily accessible and can be programmed to be presented on the fly with pull-down menus and/or with non-obtrusive pop-ups. These menus and pop-ups do not interfere with or slow down the search at hand. This is wholly different than any other media logging software GUI that cannot be changed on the fly.

The number of keyframe events being displayed is directly proportional to the search rate choice of displayed keyframe events. The quicker the interval between the rate of keyframe events displayed, the higher the number of keyframe events shown on the screen. Thus, choosing a five second interval rate many more keyframe events will be displayed rather than by choosing an interval display rate of every ten minutes. The keyframe rate options may be lower than the rate of the current parallel search rate and may only display an available divisible slice rate.

For example, if a user is searching through keyframe events at a rate of one image every five minutes and reaches a point in the recorded media that is less than five minutes long, their keyframe rate options may be automatically reduced accordingly (such as every one second, five seconds, ten seconds, fifteen seconds, thirty seconds, or one minute intervals).

The GUI 116 may be color coded in synchronization per the appropriate pyramidal level one is on (frame rate and/or magnification level). For example, one can fluidly change from the GUI of the index screen browser on the blue level to the GUI index slide show and see the same blue color indicating the user is on the same level as before. The visual level indicators can show the same color and can also be highlighted further to indicate where one is temporally by showing current keyframe point of browsing in relation to the whole slide show.

When logging keyframes under initial parallel indexing, the media indexer 100 can collect keyframes by default at a very high rate such as every second or other programmable rate noting that the more keyframes logged the higher the consumable memory.

In addition, the media indexer 100 can be programmed to record a parallel keyframe rate exactly matching the recorded media frame rate such as thirty frames per second for NTSC video. This can become a parallel recording and allow for the ability to pull keyframes from any exacting moment. This high frame rate may utilize higher memory, but is a viable option one can choose, especially in high action modes such as when recording computer game play. Whatever the pre-programmed frequency rate, these keyframes may always be accessible, but such keyframes may not be immediately displayed. Instead they may be “called up” at interactive/flexible intervals which makes the search ability of the media indexer 100 so advantageous.

The media indexer 100 provides constant indicators, frame rate tracking, temporal awareness, pyramid magnification layer awareness, interactive temporal display, and constant keys, buttons, or icons.

Constant indicators are provided via a pyramid process that is fluid, dynamic, highly flexible, and that allows for smooth switching between views. One desirable feature of the media indexer 100 is that it can always show the viewer where they are in the recorded media using a number of ways. One of the limitations in many software that deals with keyframes and video logging is that they are often unclear as to where you are among the whole of the recorded media unless you click back to a select spot. It is easy to get lost within a recorded whole or, at minimum, this necessitates extra steps and time spent when trying to get one's bearings.

The media indexer software 114, on the other hand, can constantly display three or more temporal modes that allow one to make quick referrals to and instantly gain/maintain their bearings as well as be able to fluidly or “drop-in” from one non-linear location to another within the pyramid layering.

Referring to FIG. 8, frame rate tracking is provided because since the user is able interactively to instruct the media indexer 100 to display still index keyframe events at desired intervals and display preferences, there is a need to be able to keep track of what interval/display methods is currently on as well as to have easy access to change from one method to another thus the chosen interval is displayed through color-coordinated code notation, highlighting and printed level indicators. The rate can be shown via a highlighted rate displayed on the search rate pyramid indicator. Additionally, the keyframe rate can be printed on each frame accordingly in the index scroll version of the index screen GUI or in a visual location using the slide show GUI.

Color-coding of all related GUI indicators can be provided, so the current search position highlighted within the scrolling display of keyframes in the index screen GUI or slide show GUI may also be displayed with the same color code on the indicators such as the increment layers indicator, the pyramid level numeric indicator, the constant source media tracking screen, and keyframes indicator (within the coordinated keyframe rate color coding). Temporal awareness is provided with constant indicators that include a timeline and a highly visible clock indicator of entire media event recording.

Pyramid magnification layer awareness is advantageous and is provided when searching through many hierarchical steps so the user is aware of what magnification level they are on in the search in order to be able to return to a previous level if desired as well as for general navigation. This awareness is made available through a combination of a numeric display on the magnification counter which simply states throughout the search where the hierarchical steps one is located, and a joint time segment counter which tells where one is at in relation to the prior time segment.

For example, consider a two hour recorded video as a rectangular pizza. Prior to any searching within the recorded video the user may sees a magnification level of zero or “mag 0” since the user has not yet divided their video into slices. The user may also note that the time counter registers a statement informing them “start media segment of 02:00:00” a numerical value for two hours exactly. Finally, the user is presented with only a single large keyframe image indicating the whole video segment (or uncut pizza, if you will). The user is also asked what they would like to do through an interactive menu display. The user notes a set of keyframe rate options that are available as well as a custom input rate.

The user can choose to search through this video using keyframes at a custom interval, such as twenty minutes, and they will then receive six slices, or keyframe events, the equivalent of 120 minutes divided by twenty for each slice of minutes. Each keyframe representing one slice at a twenty minute interval with a snapshot at the front end of a twenty minute block of time.

This first slicing of the video into segments is then magnified by one, or “mag 1”. The user then commands the media indexer 100 to slice the video accordingly. The user then sees this level noted on the magnification counter marked as “mag 1”. The user may also see on the time segment counter an introductory search statement such as “initial search at sets one-six (twenty minute intervals)”.

Since this is an initial slicing and the user has not yet entered into any particular time-slice interval the initial indicator can display a general piecing up of the whole as 120 minutes divided by twenty minute equivalent to six keyframes and six sets. Had the user started an initial keyframe search of every thirty seconds, the first notation would have been “Sets 1-4 (thirty minute intervals)” which is 120 minutes divided by thirty equivalent to four keyframes and four sets. Had the user chosen to initially slice the video into thirty second interval keyframe rate, however the user would be dividing their pie into half-minute increments. In other words the user would divide the whole 120 minutes by five minutes. This would lead to two keyframes per minute and be 240 keyframes to search through for the initial round. The user would still receive a “mag 1” level indicator this time, but would now also receive a time segment notation of “Sets 1-240 (thirty second intervals)”.

For an interactive temporal display example, consider a user wishing to narrow their search within one of those six initial keyframe slices. The user may choose to enter the fourth slice indicating a block of time between 61 minutes and 80 minutes with the first block being one minute to twenty minutes, with the second slice being 21 minutes to 40 minutes, and all trailing blocks of time and associated keyframes starting on the following minute. The user then proceeds to pull their cursor across the set of displayed six keyframes towards the fourth keyframe displayed on the screen. As soon as the user pulls their cursor across other keyframes, the user may notice that there is a corresponding change in both the level and time coordinates respond to their very movement. Thus, as the user passes over the second displayed keyframe image they note the magnification counter indicates “mag 2” and the associated Time Segment Counter XX says they are at “Set 2 (21-40 minutes)”. They then cross the third keyframe and receive a similar “mag 2” magnification and this time the time segment counter notes they are on “Set 3 (31-40 minutes)”. When they reach the fourth keyframe the corresponding indicators tell them they are on “mag 2” and “Set 4 (41-50 minutes)”.

Pausing on this keyframe for a short interval (although they could also have clicked it), they may receive a pop-up inquiry asking them what they would like to do. The user may note specific command buttons to change the search keyframe interval rate. The user may also note that any choices with time interval increments larger than twenty minutes are darkened and don't respond, whereas increment choices with time intervals under twenty minutes are active. They may choose to continue their search with keyframes and then later command the media indexer 100 to slice their second segment (piece number two) accordingly. This continues accordingly reflecting the user's mouse movement and/or finger touch with touchscreens.

Changing the frame rates does not necessarily adjust the magnification level. For example, thinking of a magnification level as an apartment floor one can count the number of doors on any given floor in a number of ways without having changing floors—counting by pairs, five's, three's, and so on.

As shown in FIGS. 8-12, constant interactive command keys, buttons, or icons for both main displays including mode switcher, go back, begin/start over, keepable moment, go forward. In addition, there are control plus “Z” type pop-up buttons or shortcuts that may undo the last action or return the display and search to the prior format (of all chosen combinations such as from the slide show GUI 620 to the index screen GUI 610), control plus “F” buttons or pop-ups which may bring up a dialog box initiating a search of the vast metadata associated with the keyframes. This latter example allows for searching through the keyframe events by flexible sets of criteria such as select keyframe by text, code, or other usable reference search information within the metadata database, such as by odds or evens, or a numeric count by hundreds, etc.

The media indexer 100 can zoom in and out of displayed keyframe events. Zooming in and out of keyframe events displays allows the user to view an image at an adjustable level of magnification that the user may desire when performing certain temporal searching (generally from smaller to larger), and may be indicated by a pop-up magnifying glass symbol with either a “+” sign for zooming in or a “−” sign for zooming out. For example, when viewing an unclear keyframe event because the images are too small to see clearly, such as when using an index screen GUI 610, the user can zoom in to the affected area by touching the “zoom in” pop-up option to temporarily zoom the individual keyframe event displayed.

The level of zooming in can be set to a programmable level, as well as a default level, to temporarily switch to a full screen size roughly equivalent to the slide show GUI 620. The difference, however, is that the large size screen may appear momentarily within the active window of the index screen GUI 610, and when the user moves the cursor off of the enlarged keyframe event, the GUI can return to the normal display properties. Alternatively, when using the slide show GUI 620 a user can use a pop-up “zoom out” option to shrink the images proportionally by momentarily displaying what would appear to be a programmed zoom level of the index screen GUI 610 within the active window of the slide show GUI 620. This screen can also return to the normal display properties when the cursor is moved off of the active window.

In addition, zooming can have pop-up choices at preset levels such as fit page, fit width, fit height, as well as zooming stair step fashion, either larger or smaller, using a combination of keystrokes, mouse button clicks, or combination touchscreen strokes. For stair step zooming, for example, the user may hold down a second keystroke while clicking to jump the magnification incrementally with each stroke in one of the chosen zooming direction (e.g., either zooming in or out). Such keystrokes could include a combination such as “control plus clicking” to change the magnifying glass symbol to a “+” (plus) sign, and could zoom into the particular keyframe event. Similarly, “shift plus clicking” could be used to change the magnifying glass symbol to a “−” (negative) sign and zoom out of that same keyframe event.

Likewise, users can alternate between zooming in or zooming out by using a combination of keyboard keystrokes such as holding down the appropriate zoom direction key while clicking and changing command keys while renewing the clicking to alternate step fashion between zoom directions. This latter example allows the user to zoom in or out at random in their direction of choice. Additionally, the above can also be accomplished combining left and right clicks on a mouse, or by a series of combination finger strokes on a touchscreen.

The media indexer 100 may use a hand tool to manually drag the relative screen display of keyframe events around. This tool could be used primarily with the index screen GUI 610, however, the tool may also be used with a zoomed out slide show keyframe 620. The hand tool is similar to scroll arrows but provides a much finer level of directional control. The hand tool may be initiated as either a pop-up command or pullout menu option, or may be initiated when the user touches a frame border between displayed keyframe events displayed within the index screen GUI 610. Depending upon the zoom level, the hand tool may either move vertically or horizontally, or may move the select images omnidirectionally, such as typical of movement of images which are larger than the screen size in various applications. Alternatively, movement may be initiated by horizontal and vertical command keys in the form of arrow keys or scroll bar keys.

The media indexer 100 has browser GUI layout customization ability. Menu items may have two or more ways to accomplish the same thing from pullout menus to pop-ups or breakaway palettes with equivalent command buttons. A pullout buttons palette may be broken off to be relocated in any desired location using standard methods of moving breakaway menu buttons, such as dragging on a predefined region of a command button. These predefined pullout regions may include an arrow corner that brings up further command buttons to be initiated, or allow these same pullout buttons to be broken away for relocation. These duplicatable button palettes may remain on screen to either perform the associated function if the command button is touched.

Alternatively, the breakaway palette could be dragged around to preferred locations on the screen. Likewise, both the pullout could disappear by either clicking on a close box indicator in the corner of a pullout, or by clicking on a separate part of a screen. Additionally, breakaway palettes may be programmed to dock to specific locations of the monitor screen should the palettes get close enough to predetermined locations, such as the side of the monitor.

The above are suggested ways in which the user can design a browser GUI to have a workspace the way they like to work, such as moving the scroll bar to the left side of the screen from the right, relocating the pyramid level numeric indicator, or duplicating and positioning frequently used pop-up buttons. These examples are for illustration and are not intended to be limiting. Many standard methods for arranging the screen may be employed without varying from the scope of the claimed invention.

The media indexer 100 is configured to tag desired segments of parallel recorded keyframes to differentiate one segment of media from another separate from the source. This provides an advantage of identifying selected segments for many applications, not the least, for pre-selecting portions of a recorded video prior to transfer for video editing. This is similar to the video editing process of choosing and tagging desired moments but it is separate from the original media data. Secondly, this allows the original to be undisturbed (only forwarded from one segment to the next). In a related manner, this allows users to program the media indexer 100 to program to desired moments of a permanently recorded media such as an owned or rented DVD. Here a viewer can program the media indexer 100 to “flag” and save a collection of desired highlighted moments parallel fashion (in the nature of this invention) for later play. That way the viewer can setup an automatic play series of favorite scenes without having locate those scenes every time. In addition, since the media indexer 100 is capable of handling multiple inputs and records, it can become a form of a media jukebox which can store and play multiple media sources for multimedia play similar to any stereo music player can mix and match random music segments (only limited to the amount of memory or number of media disks inserted in the machine).

Similarly, the media indexer 100 is able to make use of chapters identification recorded onto media sources such as DVD chapters (or other media) if wanted during the flagging process.

Referring to the above regarding pre-programmability and media “flag” ability and to maintain the simplicity, the media indexer 100 can be optionally set to either have these commands pop-up on when the cursor is placed upon the chosen “tagging dots” or set for constant display similar to other buttons. Buttons involved in flagging the video segments for later interval playing include “mark in” for starting the segment moment of capture and “mark out” for ending that same segment moment of capture.

For example, when searching through the recorded media, the user finds a first desired scene or keepable moment at twenty-two minutes into the entire recorded media event, the user presses the mark-in button and receives a pop-up notation of “keep-Start 01”. The user continues searching until finding an end moment of the first segment they want to keep at twenty-eight minutes into the media event, then with a press of the mark-out button a second pop-up notation of “keep-Stop 01” tells the user that the flagging of that first segment has stopped after six minutes of flagging. The user then continues searching through the recorded media until finding another keep-worthy segment at, say forty minutes into the recorded media event, and flags both ends in the manner described above, receiving both a “keep-Start 02” and a “keep-Stop 02” for this second segment and so on.

All index moments in between the start and stop positions (as indicated through keyframes) have been flagged for retrieval for any use in accordance with the invention. From an options menu the user can decide how to make use of these segments. (sport mode display-printing/batch printing/programmed play etc.). Programmable pop-up dialog balloons may be included to tell the user what buttons they are about to press or are crossing over, or what command choices available when pressing a “keepable moment” (and a pull down menu appears).

Additionally, as one moves through the pyramidal searching process, individual moments may appear where one wants to print of specific key frame indexes at higher quality at a later time. A similar process of flagging particular keyframe events can be done in a fluid manner ad-hoc and on the fly, while moving temporally through the recorded media. For example, as the user changes from one level to the next, perhaps they do not want to collect or return to any video segment, but desire to make print off a copy of a particular moment, then all they have to do is press a “save a print” button for later retrieval and/or printing at desired quality level using these same pull down menus.

Similarly, when a cursor pauses over select buttons and indicators, “pop-up” function/identification notations may be provided that describe how the buttons operate, etc. These cursor linked pop-ups would work in a manner as typical software today. In this way, button recognition and identification would be helped.

The media indexer 100 is directly beneficial to anyone who has ever had trouble finding something they taped on a VCR recorder. Maybe they taped many different things on one tape and wanted to find some specific part but did not know where it was. Thinking how home recording is typically done—grabbing of any tape available—and it's no wonder the contents of tapes are easily lost or forgotten. The media indexer 100 is beneficial to anyone who ever had to search through six tapes before finally locating some desired moment or for those who have lost “forever” lost cherished moments. The media indexer 100 allows VCRs, camcorders and other analog recordable media, as well as recordable disks (e.g., DVD−R, DVD+R, DVD−RW, DVD+RW) to have the convenience of an index print of the kind one gets from a photo developing place. The media indexer 100 is even capable bookmarking favorite movie scenes for instant access. The media indexer 100 offers the convenience of displaying on-screen indexed keyframe events at programmable intervals such as thirty seconds, one minute, ten minutes, etc., as well as the ability to easily access those scenes through interactive menus.

The media indexer 100 provides pyramidal image interval accessing. The media indexer 100 can be selectively programmed to display a variety of stills from recorded media or direct broadcast at desired intervals (e.g. every second to every minute or the like). The media indexer 100 provides high quality printing. The media indexer 100 can either be programmed from the onset to take high quality index keyframe events if desired (which consumes more memory) or to take index keyframe events at selected lower quality levels (less memory consumption), and interactively return to recorded source media via select moment re-play to re-print higher quality keyframe events as desired.

The media indexer 100 enables the ability to view one or more channels while indexing single or multiple other sources. The media indexer 100 enables users to watch one or more channels while indexing one or more different TV channel and input sources. In this way a user can index their favorite programs while at the same time they watch other programs, play video games, “channel surf”, or do any number of other viewing habits.

The media indexer 100 utilizes separate parallel recording of index keyframe events, these indexing keyframe events can be separately viewed, sorted, manipulated, archived, titled, shared, and the like, without the need to have the original source present. Then, when the user is ready they can command source the media indexer 100 to go to the desired location for whatever reason, such as printing, re-indexing at a higher keyframe rate, etc. Since the parallel recording contains the same index appropriate identification as the original source media (or a recording of the same) the source media need only be reconnected and/or played again to allow the interactive index capabilities to resume (such as high quality printing).

The media indexer 100 provides index keyframe events and can display sequential imaging sets equivalent to sports programs in “strobe light” manner (e.g., Stop Motion Imaging Sets). The media indexer 100, when in video game indexing mode, can record index keyframe events providing either “stop motion” moments of action, exactly parallel video, or can copy quality snapshots of game play DURING the gaming experience. Thus, the video game player can “capture” exciting moments, create/print index related keyframe events or video moments of desired rate of index keyframe events. The media indexer 100 can display multi screen displays of desired image quantity of all index keyframe events recorded. Each screen page can be reached via a continuous scroll bar, a “next page” command/arrow, or “previous page” command/arrow (similar to changing pages on the Internet while “browsing” (e.g., Index-Image Page Changing)).

The media indexer 100 can provide search interactivity, a touch sensitive screen, and “user friendly” prompting. The media indexer 100 can have its own built in quick access digital memory recorder (an internal large capacity, Hard Drive) configured to store captured sets of indexing stills. The media indexer 100 can utilize removable memory storage for archiving and sharing. Recording of index keyframe events and index sets themselves can be copied and stored on removable memory cartridges (e.g. ZIP drives, 1.44 MB floppy drives, camera-type digital memory cards, etc.) allowing for a virtually unlimited amount of memory storage and complete interactivity of usage for sorting. A user can utilize/manipulate/sort keyframe events as desired. In addition, this removable memory also allows file(s) of select index keyframe events and image sets (and associated time coded data etc.) to be exchanged from one media indexing television to another. Thus, media indexing can be shared from house to house.

The media indexer 100 includes audio index capabilities. The media indexer 100 may be configured to index audio signals also, (in the form of “sound-bites” or “sound segment” recordings, if desired by the user). The media indexer 100 may be configured with audio recorder capabilities (ACR). In the same manner that typical VCRs can be set to record television programs, the media indexer 100 can be set to record on any given day/time from either the television broadcast or the radio (this feature is convenient and helpful for disabled individuals, such as the blind).

The media indexer 100 can be integrated into a TV to provide a user friendly TV, NOT just another component to be added to the already sagging shelf of VCR's DVD players and video games etc. Many media units can be hooked up to one TV with an integrated media indexer 100 (VCRs, DVDs, etc.). Within a TV and functioning as an “indexing receiver,” the media indexer 100 can receive any compatible signal that is TV-ready. Thus, there is no need to purchase any number of index-capable media recorders of different varieties to do the same thing. Consequently, the media indexer 100 is space saving.

The media indexer 100 provides fluid-real-time “on the fly” parallel index adaptability. The indexing of any media is a dynamic changeable process, as fluid and easily changeable as the act of recording and re-recording itself. Whether utilizing pre existing index ready recordable media or by recording appropriate index information back onto recordable media, once enabled for parallel tracking, the media indexer 100 can adjust and dynamically modify any and all indexing keyframe events “on-the-fly” directly alongside of recording habits of the user. One example is when a viewer records onto new tape or re-records over previously recorded segments. In this manner, image-indexing/re-indexing exactly follows typical recording and re-recording habits of VCR, DVD recorder, camcorder, and media recorders alike.

The media indexer 100 possesses a removability and separation capability from the source of recordable media while still providing source media accountability. Take the following illustration for example: after finding a desired movie ABC on a media index catalog off the Internet, viewer Gabbi downloads this media indexer metadata to her media indexer 100 at her home using a standard modem copying a keyframe events rate of one keyframe event every thirty seconds. Then she turns on her DVD player and inserts her rental copy of the movie DVD rental. Viewer Gabbi is now able to find any moment she wants using her media indexer 100 and by searching through the downloaded media indexer metadata.

Viewer Gabbi chooses to pull only audio sound bites of explosions to add to her punk rock/country music soundtrack demo music CD she is making to send to music producers. On the other hand, when Gabbi calls her friend Rohana to tell her the latest, her friend asks Gabbi to bring the rented DVD to watch together. Gabbi brings her demo tape along with both the video and media indexer information for play on Rohana's media indexer 100. Both girls listen to Gabbi's demo tape while watching the same moments by fast forwarding the rented DVD to the selected explosive moments.

Finally, Gabbi decides to let her girlfriend, Zhu, watch the rented DVD before she has to return it a few days later. Zhu, who does not have much time as a veterinarian student, only wants to watch the animal parts and asks to borrow Gabbi's downloaded media indexer data about movie ABC. She then inserts the floppy disk into her drive and displays the contents displaying thumbnails and associated timecode displays of all at thirty second intervals. Zhu then enjoys watching all animal moments, by manually fast forwarding the DVD to times identified by her computer display screen. The latter example shows the media indexer's share ability even to those without a media indexer 100.

The unique identifier is a form of identification that is either recorded onto any magnetically recordable media or exploits the inherent temporal and identification data of permanent memory media such as DVDs and the like. When recorded onto recordable media lacking distinguishing index data (such VHS tapes) this form of identification is recorded at appropriate intervals on some nonvisual, inaudible portions of the recordable media. For this type of media the media indexer 100 can lay down such a unique identification “stamp” continuously at appropriate intervals during a onetime form of “Indexing fast-forward.” Accordingly, virgin blank media can be recorded and be “Indexed” while being recorded for the first time.

The media indexer 100 can automatically title any given older generation recordable media that lacks usable inherent timecodes or ID data. For most of cases, this will include VHS cassettes and the like. An automatic titling, such as a date derived title and included cardinal number of ordinal position will suffice. An example of this would be 071402-02, where “071402” is the date Jul. 14, 2002, and “02” refers to the second tape inserted and recorded onto that day. This alphanumeric date would provide a “unique identifier” which would be permanently recorded onto any recordable media during the initial recording, or at given intervals. This unique identifier serves as a permanent internal identification for the media indexer 100 itself and can be linked to a more flexible, editable, easy-to-remember title wanted. In other words, the media indexer 100 does NOT actually change the unique identifier, only its “user friendly” title counterpart changes. For example, 071402-01 can be re titled “weekly taping 01”. Thus, “weekly taping 01” is a title that is then be displayed to the viewer. The user title can be re-titled as often as wanted, and is merely re-linked to the ORIGINAL ID title provided by the media indexer 100. That same tape might later be re-taped over with a made-for-TV movie. Then this tape might later be re-titled “Dinosaurian” but, internally, the original date-encoded identifier of “042102-3” is what the media indexer actually uses to identify the original re-recorded tape.

A key difference between the time code of the media indexer 100 and usable unique identification system with that of typical time code capable media is that when one inserts a tape into such machines (whether tapes are previously recorded onto or not) the machines' counters always “zero out.” The media indexer 100, on the other hand, by default searches for prior recorded media indexer identification and/or permanent identification and time code of permanently recorded media such as rental DVDs or, depending upon the media, write its own unique identification and time counter on the recordable media. For analog media, when a media indexer compatible tape re-inserted into the source media attached to the media indexer 100, the media indexer 100 can not only identify which tape it is, the media indexer 100 can also sense the temporal location of the tape—how far forward or reversed it is—no matter how much tape has been recorded onto, or has yet to be taped. This same tape can be rewound, forwarded, removed, reinserted and recorded onto again (at any recording speed), and the media indexer 100 can keep up with any tape configuration or adjustment. Thus, any given media can be forwarded, rewinded, and even removed and re-inserted. The media indexer 100 can instantaneously identify and find where and when an analog tape is at any given time.

The temporal and identification capabilities of a DVD player recorder and the like, and the ability to support a rich amount of multimedia and metadata along with video and audio, make them very usable tools upon which to expand. DVD and other disk systems have a different arrangement of recorded images and sounds. Unlike analog recorded media that present information in a linear manner, these disk type media have information retrieved through “spinning of a disk” where internal readers pull chronological information in sequence. With non recordable disks and the like, the media indexer 100 simply makes use of the disk's encoded “titling” and timecode information and make its own keyframe event copies accordingly. With recordable disk media the process is generally the same as analog index indexing where the media indexer 100 can lay down its own unique identification during the initial media recording phase.

Thus, any given media, such as a VCR, camcorder, recordable DVD, or tape can be forwarded, rewinded, and even removed and re-inserted or removed/reattached and the media indexer 100 can instantaneously locate where and when an analog tape (or other media) is at any given time. As is often the case, someone may grab any available tape and record some desired video, or broadcast program from the television (or other source) on the spur of the moment. This is a dynamic, flexible re-identification similar to the dynamic re-recording of any video tape and media which can be fluidly re-recorded onto.

Integration of any media of older “non-index” variety (any media without index-identification data such and/or no time counter) can be used. Such older tapes/any non-index-recorded tape variety can be “modified” to become indexable via the media indexer 100. Older forms of cassette tapes can be “prepared” for use by the media indexer 100 quite easily. These older tapes merely need to have a unique identification system and time stamp recorded back onto them.

This can be accomplished merely by having a previously recorded (and non-indexed) media run through the media indexer 100 at a later time through a process of “fast-forward identification imprinting” where the appropriate index linking information is encoded/recorded onto tape media. Once indexed however, the media indexer 100 keeps track of where a tape is in the recording process and “adds or deletes” its own indexing snapshots of scenes being recorded or recorded over if and when they are being recorded.

If the tape/media is forwarded or reversed, then the media indexer 100 merely adjusts its chronological timestamp “position” accordingly, ready to re-adjust index keyframe events at the same moments the tape/media is re-recorded onto. Just think how wonderful it would be if the owner of old wedding tapes recorded ten years ago, now had the capability to index those all those cherished moments from their wedding ceremony, and even easily print off high quality photos of these moments with the simple input of a “GO TO/PRINT command”.

The media indexer 100 may be configured to utilize pre-manufactured index ready media. The media indexer 100 can utilize any blank/unrecorded media form such as “blank” video cassettes, mini-DV cassette tapes, blank VCD, DVD disks and the like. These “blank” typically unrecorded media can be pre-manufactured with an index-usable data which is recorded in supplementary location of the recordable media for use by the media indexer 100. This includes future video cassette production of mainstream Hollywood Industry rental movies and the like, which are typically designed not to be recorded onto, but which can benefit from the indexing capabilities. These rental tapes and disks can be manufactured to include pre-recorded index-data to do the same. This can, in some ways, revitalize the Video Cassette industry if these new VHS tapes can be easily accessed, and interactively viewed in manners similar to DVDs and typical digital media of today; it can also increase the popularity of rental DVDs and other media.

The media indexer 100 can use standard timecodes used by index capable recording machines. Timecodes are counters used to identify individual frames of a video and to time stamp the various pieces of metadata associated with the video. In addition, timecodes are also used to approximate the real time elapses of the video. Timecodes are usually expressed in SMPTE (Society of Motion Picture and Television Engineers) format. There are two types of the SMPTE timecodes. These include non-drop frame and drop frame.

Both systems use the standard HH:MM:SS:FF format where HH denotes hours, MM denotes minutes, SS denotes seconds, and FF denotes frames. Non-drop frame SMPTE timecodes have a discrepancy rate of 3.5 seconds, or 108 frames per hour when compared to the NTSC video standard of 29.97 frames per second. SMPTE timecodes are widely used as temporal recording methods relative to each frame of recorded video and other media. Non-drop frame SMPTE timecodes assign a unique time stamp to each frame of video based on the frame rate of 30 frames per second for NTSC and 25 frames per second for PAL. The drop frame SMPTE timecode, however, is based on the actual frame rate for the NTSC video standard (29.97 frames per second). Since the number of seconds in the timecode cannot be incremented every 29.97 frames, the drop frame timecode uses a rate of 30 frames per second and adjusts the accuracy by skipping the first two frame numbers each minute (except every tenth minute).

The media indexer 100 can use either SMPTE timecodes pertaining to source media. However, what is often the case, is that SMPTE timecodes are often non-continous or have multiple timecode counts that result when tapes are reinserted or recording stops and restarts. The time counter then “zeros out” (e.g., go to ‘00:00:00:00’). This is a common occurrence with camcorders and VHS tapes. Due to this possibility of non-continuous SMPTE timecodes the media indexer 100 internally also uses its own time counter identification to stamp all metadata from the source when accessing recordable media with SMPTE timecodes. However, when non recordable media sources are used, such as purchased CD or DVD cassettes, this form of time stamping is unchangeable and usually provides a single timecode count, and this option is generally viable. In addition, it should be noted that when synchronizing to timecode sources, the media indexer 100 can synchronize down to milliseconds.

The media indexer 100 provides true universality of media indexing since it accesses video-out signals and broadcast signals and by recording indexing keyframe events on a separate parallel memory track. One media indexer 100 can be hooked up to ANY TV-ready media and virtually ANY non-recordable media can also be indexed, such as Blockbuster VCR rental tapes and DVDs, for example, as long as such media already has an imbedded internal time counter and imbedded media identification.

Any desired video game console 34 (see FIG. 1) may be integrally configured with media indexer circuitry according to the invention. Such a system includes a controller operated by a game player, a storage medium storing a game program data, a video game processing unit for executing controls to generate sounds and keyframe events based on the game program data, an video image processor for generating keyframe events, an audio processor for generating sounds, a display for displaying keyframe events, and a audible output device, such as a speaker or the like, for making sounds audible. Any desired computer device may be integrally configured with media indexing circuitry according to the invention, such as a wireless or non-wireless palm-top, lap-top, personal computer, workstation, or the like.

Consequently, the media indexer 100 provides improved search and retrieval methods in media for the home user, media oriented business, law enforcement, video surveillance, and video editing, as well as anyone who intends to view and retrieve rich media content in an effective time saving and user-friendly manner. The media indexer 100 can become a standard law enforcement tool for searching and retrieving media signal evidence. Additionally, the media indexer 100 can be a standard tool for business and home users who are eager and able to manipulate and exploits to their advantage the multi layered rich media data sources included in today's integrated data files of multimedia and streaming communications.

The media indexer 100 is configured to link up to other logging and index software which to perform similar as well as different tasks. This linking ability greatly enhances the searchability and logging capabilities of the media indexer 100 by being able to link to such advanced media analysis capabilities as on-screen text recognition, face recognition plug-ins, optical character recognition (OCR), multi-language speech, speaker identification, audio classification plug-ins, etc. Compatible software linking provides a treasure trove of logging tools.

For example, say someone is interested in collecting a mass of video segments featuring a favorite actor. They can log onto a media server on the internet that utilizes their own metadata logging culled from many various sources which feature this particular actor. The server may then return the results from a logging search which includes sixteen hours of video clips related to that actor ready to sell to the user, who then purchases and downloads this set of clips from the media search provider. However, now the user has sixteen hours of recorded media moments of primarily unknown moments. They are now in the same boat as the home video camera buff possessing a mountain of recorded home video tapes. The media indexer 100 can take over from here and further refine the search by which the extracted actor segments can be indexed to find an exact frame or video segment wanted.

In addition, the media indexer 100 can be configured to be compatible to work with any number of other full, or “lite,” version media analysis software. Through this, the media indexer 100 can not only use, but also share the results of its own index sources with those very same “big gun” media servers, thus linking to the vast expanse of the video logging networks. Similarly, the media indexer 100 can transmit and use manipulated media and metadata files resulting from compatible computer video editing software to be used internally or be shared out. This leads to another advantage of the invention, file sharing.

The media indexer 100 can be linked to a wide audience. Since the media indexer 100 can save its processed index files and segmented key frames in a standard format, such as MPEG, JPEG, etc., these standard formats allow it to be utilized by a wide populace beyond other media logging servers. Also, since the media indexer 100 can send out its data to a wide variety of locations, in addition to removable media (such as CDs and Flash drives), the media indexer 100 can send out its index data information in the same manner in which it receives data.

Thus, index image sets can be shared with a much broader population either through the internet, wirelessly, or through any effective data transmitting techniques. Not unlike the file sharing of Napster and eBay, the media indexer 100 can become an integral component in a larger network system of the media savvy who are eager to have and share their similar metadata and media logging interests. This file sharing capability can expand into a linked community who share their own and make use of other's index-information.

In addition, such file sharing could also occur with DVR user brands, such as TiVo and ReplayTV, along with their associated DVR services. Due to features such as video on demand, automatic preference recording (which records programs while the user is away), and advanced content searching, the users of these services and recorders amass many more hours of video and media than the average home media user. The media indexer 100 can provide an excellent search assist means with this highly increased collection of media. In addition, these users can now share superior keyframe and metadata search results with each other thanks to the media indexer 100.

In summary, a media indexer method, a media indexer, and/or a media indexer computer useable medium can each receive a media signal, identify keyframes of the media signal, establish metadata for each identified keyframe, tag each identified keyframe with metadata established for the associated keyframe, and output the media signal in a form unchanged from the received media signal, a form including identified keyframes of the received media signal, each identified keyframe including a representative media keyframe event with metadata associated with the corresponding media keyframe event, or a combination of a form unchanged from the received media signal and a form including identified keyframes of the received media signal, each identified keyframe including a representative media keyframe event with metadata associated with the corresponding media keyframe event. The media indexer 100 can generate parallel index signals that are synchronized to the time rate of the received media signal, and can input and output data using standard compatible file formats for file sharing and data manipulations with other compatible files and software. The media indexer can also temporally indicate a keyframe point of the received media signal in relation to a keyframe sequence having a predetermined quantity of keyframes.

The media indexer 100 can be provided with memory, and be configured to receive the media signal from a media signal source device, record and store the processed media signal in a memory location of the memory of the media indexer, interpret supplementary-broadcast data associated with the media signal, read time-counter and index-identification data associated with the media signal, provide time-counter and index-identification data to outgoing media signals in the form of supplemental parallel broadcast index signals, and display at least one still index keyframe event from incoming media signals at any predetermined time interval.

The memory can be configured to form a media jukebox that enables users to program a collection of media moments to view, to pre-edit out media moments, or exclude media moments. The memory can include a hierarchical browser GUI, an index screen GUI, a slide show GUI, a strobe navigator GUI, a strobe navigator GUI configured to show mid strobe and black intra-key frame moments, or a strobe navigator graphical user interface showing mid strobe and darkened intra-keyframe moments.

The media indexer 100 can recombine keyframe events to form a time lapse sequence of keyframe events at desired intervals from collected keyframes, or recombine the keyframe events to form a time lapse sequence of keyframe events at desired intervals from the collected keyframes. The media indexer 100 can interactively present still index keyframe events in a pyramid layering manner, capture a fluid action of desired moments of the media signal, output and cause to be displayed fluid stop motion still index keyframe events in index-fashion of the desired moments of the media signal, copy processed media signals, and print processed media signals on a printer.

The media indexer 100 can output and cause to be displayed a multi-screen index sampling of still index keyframe events, interpret a sub image stream of supplementary-broadcast data included in an incoming digital media signal, interpret closed captioning text data within vertical blanking interval data of media signals, or interpret textual data within vertical blanking interval data of analog media signals. The media indexer 100 can also interconnect with other logging and index software to effect functional capability of the other logging and index software on the media signal, interpret results from the other logging and index software, and display a multi-screen index sampling of still index keyframe events from the interpreted results.

While the invention has been described with references to its preferred embodiment, it will be understood by those skilled in the art that various changes may be made and equivalents may be substituted for elements thereof without departing from the true spirit and scope of the invention.

1. A method for indexing media comprising:
receiving a media signal;
identifying keyframes of the media signal;
establishing metadata for each identified keyframe;
tagging each identified keyframe with metadata established for the associated keyframe; and
outputting the media signal in a form selected from the group consisting of (a) a form unchanged from the received media signal, (b) a form including identified keyframes of the received media signal, each identified keyframe including a representative media keyframe event with metadata associated with the corresponding media keyframe event, and (c) a combination of a form unchanged from the received media signal and a form including identified keyframes of the received media signal, each identified keyframe including a representative media keyframe event with metadata associated with the corresponding media keyframe event.

2. The method according to claim 1, wherein said outputting the media signal step further comprises:
outputting the media signal outputting the media signal in a form unchanged from the received media signal.

3. The method according to claim 1, wherein said outputting the media signal step further comprises:
outputting the media signal outputting the media signal in a form including identified keyframes of the received media signal, each identified keyframe including a representative media keyframe event with metadata associated with the corresponding media keyframe event.

4. The method according to claim 1, wherein said outputting the media signal step further comprises:
outputting the media signal outputting the media signal in a combination of a form unchanged from the received media signal and a form including identified keyframes of the received media signal, each identified keyframe including a representative media keyframe event with metadata associated with the corresponding media keyframe event.

5. The method according to claim 1, wherein said outputting the media signal step further comprises:
generating parallel index signals that are synchronized to a time rate of the received media signal.

6. The method according to claim 1, further comprising:
inputting/outputting data using standard compatible file formats for file sharing and data manipulations with other compatible files and software.

7. The method according to claim 1, further comprising:
temporally indicating a keyframe point of the received media signal in relation to a keyframe sequence having a predetermined quantity of keyframes.

8. The method according to claim 1, further comprising:
undoing a last action or returning a display and search to a prior format;
zooming in and out of displayed keyframe events; and
providing a hand tool for navigation of zoomed keyframe events.

9. The method according to claim 1, further comprising:
employing a hierarchical browser graphical user interface.

10. The method according to claim 1, further comprising:
employing an index screen graphical user interface.

11. The method according to claim 1, further comprising:
employing a slide show graphical user interface.

12. The method according to claim 1, further comprising:
employing a strobe navigator graphical user interface.

13. The method according to claim 1, further comprising:
employing a strobe navigator graphical user interface configured to show mid strobe and black intra-key frame moments.

14. The method according to claim 1, further comprising:
employing a strobe navigator graphical user interface showing mid strobe and darkened intra-keyframe moments.

15. The method according to claim 1, further comprising:
recombining the keyframe events to form a time lapse sequence of keyframe events at desired intervals from collected keyframes.

16. The method according to claim 1, further comprising:
recombining the keyframe events to form a time lapse sequence of keyframe events at desired intervals from the collected keyframes.

17. The method according to claim 1, further comprising:
interactively presenting still index keyframe events in a pyramid layering manner.

18. The method according to claim 1, further comprising:
capturing a fluid action of desired moments of the media signal.

19. The method according to claim 17, further comprising:
outputting and causing to be displayed fluid stop motion still index keyframe events in index-fashion of desired moments of the media signal.

20. The method according to claim 19, further comprising:
copying processed media signals; and
printing processed media signals on a printer.

21. The method according to claim 20, further comprising:
outputting and causing to be displayed a multi-screen index sampling of still index keyframe events.

22. The method according to claim 1, further comprising:
interpreting a sub image stream of supplementary-broadcast data included in an incoming digital media signal.

23. The method according to claim 1, further comprising:
interpreting closed captioning text data within vertical blanking interval data of media signals.

24. The method according to claim 1, further comprising:
interpreting textual data within vertical blanking interval data of analog media signals.

25. The method according to claim 1, further comprising:
interconnecting with other logging and index software to effect functional capability of the other logging and index software on the media signal.

26. The method according to claim 1, further comprising:
interpreting results from the other logging and index software;
displaying a multi-screen index sampling of still index keyframe events from the interpreted results.

27. The method for indexing media according to claim 1, further comprising:
providing a media indexer with memory, said media indexer being configured to receive the media signal from a media signal source device;
recording and storing the processed media signal in a memory location of the memory of the media indexer;
interpreting supplementary-broadcast data associated with the media signal;
reading time-counter and index-identification data associated with the media signal;
providing time-counter and index-identification data to outgoing media signals in the form of supplemental parallel broadcast index signals; and
displaying at least one still index keyframe event from incoming media signals at any predetermined time interval.

28. The method according to claim 27, further comprising:
providing the media indexer with a central processor, a tuner, at least one video processor, at least one audio processor, at least one video encoder, at least one audio encoder, at least one multimedia encoders, a modem, at least one input/output connector, at least one input/output switch, and an antenna.

29. The method according to claim 27, further comprising configuring the memory to form a media jukebox that enables users to program a collection of media moments to view, to pre-edit out media moments, or exclude media moments.

30. A media indexer comprising:
a central processor; and
a memory;
wherein said memory carries thereon media indexer software, which, when executed by the central processor, causes the central processor to carry out steps comprising:
receiving a media signal;
identifying keyframes of a media signal;
establishing metadata for each identified keyframe;
tagging each identified keyframe with metadata established for the associated keyframe; and
outputting the media signal in a form selected from the group consisting of (a) a form unchanged from the received media signal, (b) a form including identified keyframes of the received media signal, each identified keyframe including a representative media keyframe event with metadata associated with the corresponding media keyframe event, and (c) a combination of a form unchanged from the received media signal, and a form including identified keyframes of the received media signal, each identified keyframe including a representative media keyframe event with metadata associated with the corresponding media keyframe event.

31. The media indexer according to claim 30, further comprising:
a hierarchical browser graphical user interface carried on the memory.

32. The media indexer according to claim 30, further comprising:
an index screen graphical user interface carried on the memory.

33. The media indexer according to claim 30, further comprising:
a slide show graphical user interface carried on the memory.

34. The media indexer according to claim 30, further comprising:
a strobe navigator graphical user interface carried on the memory.

35. The media indexer according to claim 30, further comprising:
a strobe navigator graphical user interface carried on the memory that is configured to show mid strobe and black intra-key frame moments.

36. The media indexer according to claim 30, further comprising:
a strobe navigator graphical user interface carried on the memory that is configured to show mid strobe and darkened intra-keyframe moments.

37. The media indexer according to claim 30, wherein the further comprising:
a strobe navigator graphical user interface carried on the memory that is configured to show mid strobe and darkened intra-keyframe moments.

38. The media indexer according to claim 30, further comprising:
a tuner;
at least one video processor;
at least one audio processor;
at least one video encoder;
at least one audio encoder;
at least one multimedia encoders;
a modem;
at least one input/output connector;
at least one input/output switch; and
an antenna.

39. The media indexer according to claim 30, wherein the media indexing software further causes the processor to carry the steps comprising:
outputting the media signal outputting the media signal in a form unchanged from the received media signal.

40. The media indexer according to claim 30, wherein the media indexing software further causes the media indexer to carry out steps comprising:
outputting the media signal outputting the media signal in a form including identified keyframes of the received media signal, each identified keyframe including a representative media keyframe event with metadata associated with the corresponding media keyframe event.

41. The media indexer according to claim 30, wherein the media indexing software further causes the media indexer to carry out steps comprising:
outputting the media signal outputting the media signal in a combination of a form unchanged from the received media signal and a form including identified keyframes of the received media signal, each identified keyframe including a representative media keyframe event with metadata associated with the corresponding media keyframe event.

42. The media indexer according to claim 30, wherein the media indexing software further causes the media indexer to carry out steps comprising:
generating parallel index signals that are synchronized to a time rate of the received media signal.

43. The media indexer according to claim 30, wherein the media indexing software further causes the media indexer to carry out steps comprising:
inputting/outputting data using standard compatible file formats for file sharing and data manipulations with other compatible files and software.

44. The media indexer according to claim 30, wherein the media indexing software further causes the media indexer to carry out steps comprising:
temporally indicating a keyframe point of the received media signal in relation to a keyframe sequence having a predetermined quantity of keyframes.

45. The media indexer according to claim 30, wherein the media indexing software further causes the media indexer to carry out steps comprising:
undoing a last action or returning a display and search to a prior format;
zooming in and out of displayed keyframe events; and
providing a hand tool for navigation of zoomed keyframe events.

46. The media indexer according to claim 30, wherein the media indexing software further causes the media indexer to carry out steps comprising:
outputting and causing to be displayed fluid stop motion still index keyframe events in index-fashion of desired moments of the media signal to result in a time-lapse of compressed timeline qualities.

47. The media indexer according to claim 30, wherein the media indexer is configured to generate parallel index signals that are synchronized to a time rate of a received media signal.

48. The media indexer according to claim 30, wherein the media indexer is further configured for recording and storing the processed media signal in a memory location of the memory.

49. The media indexer according to claim 30, further comprising input keys and a remote control unit.

50. The media indexer according to claim 30, wherein the memory carries media indexer software which, when executed by the processor, further causes the media indexer to carry out steps comprising:
interactively presenting still index keyframe events in a pyramid layering manner.

51. The media indexer according to claim 30, wherein the memory carries media indexer software which, when executed by the processor, further causes the media indexer to carry out steps comprising:
capturing a fluid action of desired moments of a media signal.

52. The media indexer according to claim 51, wherein the memory carries media indexer software which, when executed by the processor, further causes the media indexer to carry out steps comprising:
outputting and causing to be displayed fluid stop motion still index keyframe events in index-fashion of the desired moments of the media signal.

53. The media indexer according to claim 30, wherein the memory carries media indexer software which, when executed by the processor, further causes the media indexer to carry out steps comprising:
copying processed media signals; and
printing processed media signals on a printer interconnected with the media indexer.

54. The media indexer according to claim 30, wherein the memory carries media indexer software which, when executed by the processor, further causes the media indexer to carry out steps comprising:
outputting and causing to be displayed a multi-screen index sampling of still index keyframe events.

55. The media indexer according to claim 30, wherein the memory carries media indexer software which, when executed by the processor, further causes the media indexer to carry out steps comprising:
interpreting a sub image stream of supplementary-broadcast data included an in incoming digital media signal.

56. The media indexer according to claim 30, wherein the memory carries media indexer software which, when executed by the processor, further causes the media indexer to carry out steps comprising:
interpreting closed captioning text data within vertical blanking interval data of media signals.

57. The media indexer according to claim 30, wherein the memory carries media indexer software which, when executed by the processor, further causes the media indexer to carry out steps comprising:
interpreting textual data within vertical blanking interval data of analog media signals.

58. The media indexer according to claim 30, wherein the memory carries media indexer software which, when executed by the processor, further causes the media indexer to carry out steps comprising:
interconnecting with other logging and index software to effect functional capability of the other logging and index software on the media signal.

59. The media indexer according to claim 30, wherein the memory carries media indexer software which, when executed by the processor, further causes the media indexer to carry out steps comprising:
interpreting results from the other logging and index software; and
displaying a multi-screen index sampling of still index keyframe events from the interpreted results.

60. The media indexer according to claim 30, wherein the media indexer software further causes the processor to carry out steps comprising:
recording and storing the processed media signal in a memory location of the memory of the media indexer;
interpreting supplementary-broadcast data associated with the media signal;
reading time-counter and index-identification data associated with the media signal;
providing time-counter and index-identification data to outgoing media signals in the form of supplemental parallel broadcast index signals; and
displaying at least one still index keyframe event from incoming media signals at any predetermined time interval.

61. The media indexer according to claim 60, further comprising configuring the memory to form a media jukebox that enables users to program a collection of media moments to view, to pre-edit out media moments, or exclude media moments.

62. A computer useable medium carrying media indexer software which, when executed by a processor, causes the processor to carry out steps comprising:
receiving a media signal;
identifying keyframes of a media signal;
establishing metadata for each identified keyframe;
tagging each identified keyframe with metadata established for the associated keyframe; and
outputting the media signal in a form selected from the group consisting of (a) a form unchanged from the received media signal, (b) a form including identified keyframes of the received media signal, each identified keyframe including a representative media keyframe event with metadata associated with the corresponding media keyframe event, and (c) a combination of a form unchanged from the received media signal, and a form including identified keyframes of the received media signal, each identified keyframe including a representative media keyframe event with metadata associated with the corresponding media keyframe event.

63. The computer useable medium according to claim 62, wherein the media indexer software includes a hierarchical browser graphical user interface.

64. The computer useable medium according to claim 62, wherein the media indexer software includes an index screen graphical user interface.

65. The computer useable medium according to claim 62, wherein the media indexer software includes a slide show graphical user interface.

66. The computer useable medium according to claim 62, wherein the media indexer software includes a strobe navigator graphical user interface.

67. The computer useable medium according to claim 62, wherein the media indexer software includes a strobe navigator graphical user interface configured to show mid strobe and black intra-key frame moments.

68. The computer useable medium according to claim 62, wherein the media indexer software includes a strobe navigator graphical user interface configured to show mid strobe and darkened intra-keyframe moments.

69. The computer useable medium according to claim 62, wherein the media indexer includes a strobe navigator graphical user interface configured to show mid strobe and darkened intra-keyframe moments.

70. The computer useable medium according to claim 62, in combination with a media indexer comprising:
a central processor;
a memory;
a tuner;
at least one video processor;
at least one audio processor;
at least one video encoder;
at least one audio encoder;
at least one multimedia encoders;
a modem;
at least one input/output connector;
at least one input/output switch; and
an antenna.

71. The combination according to claim 70, wherein the media indexer is configured to generate parallel index signals that are synchronized to a time rate of a received media signal.

72. The combination according to claim 70, wherein the media indexer is further configured for recording and storing a processed media signal in a memory location of the memory.

73. The combination according to claim 70, further comprising input keys and a remote control unit.

74. The combination according to claim 70, wherein the media indexer is further configured for recording and storing the processed media signal in a memory location of the memory.

75. The computer useable medium according to claim 62, wherein the media indexing software further causes the processor to carry out steps comprising:
outputting the media signal in a form unchanged from the received media signal.

76. The computer useable medium according to claim 62, wherein the media indexing software further causes the processor to carry out steps comprising:
outputting the media signal in a form including identified keyframes of the received media signal, each identified keyframe including a representative media keyframe event with metadata associated with the corresponding media keyframe event.

77. The computer useable medium according to claim 62, wherein the media indexing software further causes the processor to carry out steps comprising:
outputting the media signal in a combination of a form unchanged from the received media signal and a form including identified keyframes of the received media signal, each identified keyframe including a representative media keyframe event with metadata associated with the corresponding media keyframe event.

78. The computer useable medium according to claim 62, wherein the media indexing software further causes the processor to carry out steps comprising:
generating parallel index signals that are synchronized to a time rate of the received media signal.

79. The computer useable medium according to claim 62, wherein the media indexing software further causes the processor to carry out steps comprising:
inputting/outputting data using standard compatible file formats for file sharing and data manipulations with other compatible files and software.

80. The computer useable medium according to claim 62, wherein the media indexing software further causes the processor to carry out steps comprising:
temporally indicating a keyframe point of the received media signal in relation to a keyframe sequence having a predetermined quantity of keyframes.

81. The computer useable medium according to claim 62, wherein the media indexing software further causes the processor to carry out steps comprising:
undoing a last action or returning a display and search to a prior format;
zooming in and out of displayed keyframe events; and
providing a hand tool for navigation of zoomed keyframe events.

82. The computer useable medium according to claim 62, wherein the media indexing software further causes the processor to carry out steps comprising:
outputting and causing to be displayed fluid stop motion still index keyframe events in index-fashion of desired moments of the media signal to result in a time-lapse of compressed timeline qualities.

83. The computer useable medium according to claim 62, wherein the media indexer software further causes the processor to carry out steps comprising:
interactively presenting still index keyframe events in a pyramid layering manner.

84. The computer useable medium according to claim 62, wherein the media indexer software further causes the processor to carry out steps comprising:
capturing a fluid action of desired moments of the media signal.

85. The computer useable medium according to claim 62, wherein the media indexer software further causes the processor to carry out steps comprising:
outputting and causing to be displayed fluid stop motion still index keyframe events in index-fashion of the desired moments of the media signal.

86. The computer useable medium according to claim 62, wherein the media indexer software further causes the processor to carry out steps comprising:
copying processed media signals; and
printing processed media signals on a printer interconnected with the media indexer.

87. The computer useable medium according to claim 62, wherein the media indexer software further causes the processor to carry out steps comprising:
outputting and causing to be displayed a multi-screen index sampling of still index keyframe events.

88. The computer useable medium according to claim 62, wherein the media indexer software further causes the processor to carry out steps comprising:
interpreting a sub image stream of supplementary-broadcast data included an in incoming digital media signal.

89. The computer useable medium according to claim 62, wherein the media indexer software further causes the processor to carry out steps comprising:
interpreting closed captioning text data within vertical blanking interval data of media signals.

90. The computer useable medium according to claim 62, wherein the media indexer software further causes the processor to carry out steps comprising:
interpreting textual data within vertical blanking interval data of analog media signals.

91. The computer useable medium according to claim 62, wherein the media indexer software further causes the media indexer to carry out steps comprising:
interconnecting with other logging and index software to effect functional capability of the other logging and index software on the media signal.

92. The computer useable medium according to claim 62, wherein the media indexer software further causes the processor to carry out steps comprising:
interpreting results from the other logging and index software; and
displaying a multi-screen index sampling of still index keyframe events from the interpreted results.

93. The computer useable medium according to claim 62, wherein the media indexer software further causes the processor to carry out steps comprising:
recording and storing the processed media signal in a memory location of the memory of the media indexer;
interpreting supplementary-broadcast data associated with the media signal;
reading time-counter and index-identification data associated with the media signal;
providing time-counter and index-identification data to outgoing media signals in the form of supplemental parallel broadcast index signals; and
displaying at least one still index keyframe event from incoming media signals at any predetermined time interval.

94. The computer useable medium according to claim 62, wherein the computer useable medium is configured to form a media jukebox that enables users to program a collection of media moments to view, to pre-edit out media moments, or exclude media moments.
